(19) United States
(12) Patent Application Publication
(10) Pub. No.: US 2023/0422336 A1
(43) Pub. Date: Dec. 28, 2023

(54) METHOD AND DEVICE FOR WIRELESS COMMUNICATION

(71) Applicants: Yu CHEN, SHANGHAI (CN); Xiaobo ZHANG, Shanghai (CN)

(72) Inventors: Yu CHEN, SHANGHAI (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/244,303

(22) Filed: Sep. 11, 2023

Related U.S. Application Data
(63) Continuation of application No. PCT/CN2022/080781, filed on Mar. 14, 2022.

(30) Foreign Application Priority Data
Mar. 17, 2021 (CN) 202110285044.3

(51) Int. Cl. H04W 76/20; H04W 16/24

(52) U.S. Cl. CPC H04W 76/20; H04W 16/24; H04W 80/02

(57) ABSTRACT

The present application discloses a method and a device for wireless communications, including: receiving a first signaling and a second signaling; the first signaling configuring at least one RLC entity of a first cell group, while the second signaling configuring at least one RLC entity of a second cell group; and transmitting a first message, the first message requesting a stop of transmission for a target cell group within a first time window set; the first time window set at least comprising one time window; herein, the target cell group is one of the first cell group or the second cell group, where each of the first cell group and the second cell group respectively comprises at least one cell; at least one of the at least one RLC entity of the first cell group. The present application helps reduce conflicts and can avoid uncertainty.

### CROSS REFERENCE TO RELATED APPLICATIONS

This application is the continuation of the international patent application No. PCT/CN2022/080781, filed on Mar. 14,2022, and claims the priority benefit of Chinese Patent Application No. 202110285044.3, filed on Mar. 17, 2021, the full disclosure of which is incorporated herein by reference.

### BACKGROUND

### Technical Field

The present application relates to transmission methods and devices in wireless communication systems, and in particular to a method for improving efficiency and reducing interruptions and delay concerning multiple network communications in wireless communications.

### Related Art

Application scenarios of future wireless communication systems are becoming increasingly diversified, and different application scenarios have different performance demands on systems. In order to meet different performance requirements of various application scenarios, the 3rd Generation Partner Project (3GPP) Radio Access Network (RAN) #72 plenary decided to conduct the study of New Radio (NR), or what is called fifth Generation (5G). The work Item (WI) of NR was approved at the 3GPP RAN #75 plenary to standardize the NR.

In communications, both Long Term Evolution (LTE) and 5G NR involves correct reception of reliable information, optimized energy efficiency ratio (EER), determination of information validity, flexible resource allocation, elastic system structure, efficient information processing on non-access stratum (NAS), and lower traffic interruption and call drop rate, and support to lower power consumption, which play an important role in the normal communication between a base station and a User Equipment (UE), rational scheduling of resources, and also in the balance of system payload, thus laying a solid foundation for increasing throughput, meeting a variety of traffic needs in communications, enhancing the spectrum utilization and improving service quality. Therefore, LTE and 5G are indispensable no matter in enhanced Mobile BroadBand (eMBB), Ultra Reliable Low Latency Communication (URLLC) or enhanced Machine Type Communication (eMTC). And a wide range of requests can be found in terms of Industrial Internet of Things (IIoT), Vehicular to X (V2X), Proximity Services (ProSe), and Device to Device (D2D), Unlicensed Spectrum communications, and monitoring on UE communication quality, network plan optimization, Non Terrestrial Network (NTN) and Terrestrial Network (TN), Dual connectivity system, or a system using Sidelink, or combined, radio resource management and multi-antenna codebook selection, as well as signaling design, neighbor management, traffic management and beamforming. Information is generally transmitted by means of broadcast/multicast and unicast, and all these ways are beneficial to fulfilling the above requests and make up an integral part of the 5G system. To enlarge the coverage of the network and improve the system's reliability, information can also be forwarded via relaying. As the capability of the communication terminal gets stronger, a communication terminal can be equipped with one Subscriber Identity Module(SIM) card or multiple SIMs. When using multiple SIMs and connecting to multiple networks, how a transceiving module of the terminal coordinates among different networks becomes a key issue.

As the number and complexity of system scenarios increases, more and more requests have been made on reducing interruption rate and latency, strengthening reliability and system stability, increasing the traffic flexibility and power conservation, and in the meantime the compatibility between different versions of systems shall be taken into account for system designing.

### SUMMARY

When a UE (i.e., user equipment, or terminal/cellphone) needs to be in communication with multiple networks, particularly when using multiple corresponding SIMs, there arises a problem of coordination among the networks. When the UE's own hardcore is not sufficient enough to support its communication with two networks simultaneously, independently, in parallel and free from any influence, if a certain degree of coordination can be provided based on the network assistance or initiated by the UE itself, mutual influences between two networks can be avoided. For instance, when the UE needs communications with another network but the network currently in communication with it also indicates its data transmission or reception, the two networks may be mutually influenced. Some UEs may be equipped with two receivers and with one or two transmitters, which means that these UEs based on their respective capabilities may be able to receive or transmit signals from or to two networks simultaneously. It depends on the specific situations, so it seems arbitrary to simply suspend the previous network or to assume that parallel transmissions and receptions of both networks can be supported. The two SIMs or multiple SIMs of the UE may be provided by different operators, which makes the coordination among the networks very limited, so it is hard to coordinate only depending on the networks, and even worse, for the sake of privacy, it is necessary to avoid the leakage of private user information from one network to another. When a UE leaves a network temporarily for a short time for receiving and/or transmitting in another network, the impact on the current network is acceptable, for instance to update a serving cell in another network. The UE is likely to stay RRC Connected with its previous network constantly, which helps the UE to resume communication as quickly as possible after returning to the original network. Due to the variety of UE capabilities, if connectivity with two networks can be kept based on different situations, it will be beneficial to data maintenance and signaling continuity for the sake of the prevention of disconnection, which is of great importance to UE with multi-connectivity capability, otherwise, the UE will probably fail the connection with one network or even get disconnected, and thus it will not live up to the performance requirements of communications. The present application solves the above problems by determining the start of a second timer and whether a target channel is to be detected.

To address the above problem, the present application provides a solution.

It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict. Besides, it should be noted that the present application applies to various cases of keeping connection with multiple parties simultaneously, but only communicating with partial peer entities, such as V2X, and the adoption of a unified solution for different scenarios can contribute to the reduction of hardcore complexity and cost.

The present application provides a method in a first node for wireless communications, comprising:
receiving a first signaling and a second signaling; the first signaling configuring at least one Radio Link Control (RLC) entity of a first cell group, while the second signaling configuring at least one RLC entity of a second cell group; and
transmitting a first message, the first message requesting a stop of transmission for a target cell group within a first time window set; the first time window set at least comprising one time window;
herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, a problem to be solved in the present application includes: when a UE supports multi-connectivity and needs to use two SIMs to connect to two networks, how to maintain its communications with the two networks according to the UE's capabilities and needs, and how to maintain the UE's multi-connectivity configurations in its previous network so that it will resume its multi-connectivity communication quickly and spontaneously after returning to the original network.

In one embodiment, an advantage of the above method includes: reducing the impact of a short leave or unavailability on the current network and keeping the network unblocked, so that a UE which leaves one network for communications with another network won't face a disconnection or a release of RRC Connection, hence a reduction of delay for resume and the guaranteed communication continuity.

Specifically, according to one aspect of the present application, a second message is received on a third cell group within the first time window set; or, transmit a third message on a third cell group within the first time window set;
herein, frequency-domain resources occupied by the third cell group are used to determine the target cell group from the first cell group and the second cell group.

Specifically, according to one aspect of the present application, a fourth message is received;
herein, the fourth message is used for acknowledging a request of the first message.

Specifically, according to one aspect of the present application, as a response to determining a link failure of a reserved cell group, a fifth message is transmitted on the target cell group within the first time window set;
herein, the fifth message indicates the link failure of the reserved cell group, where the reserved cell group is a cell group other than the target cell group between the first cell group and the second cell group.

Specifically, according to one aspect of the present application, a data unit of a first PDCP entity is received via the at least one RLC entity of the target cell group before the action of transmitting the first message; and a data unit of the first PDCP entity is received via the at least one RLC entity of a reserved cell group in the first time window set, where the reserved cell group is a cell group other than the target cell group between the first cell group and the second cell group;
herein, the first message is used for triggering a reception of a data unit of the first PDCP entity via the at least one RLC entity of the reserved cell group in the first time window set.

Specifically, according to one aspect of the present application, a data unit of a first PDCP entity is transmitted via the at least one RLC entity of the target cell group before the action of transmitting the first message; and transmit a data unit of the first PDCP entity via the at least one RLC entity of a reserved cell group in the first time window, where the reserved cell group is a cell group other than the target cell group between the first cell group and the second cell group;
herein, the first message is used for triggering a transmission of a data unit of the first PDCP entity via the at least one RLC entity of the reserved cell group in the first time window.

Specifically, according to one aspect of the present application, a data unit of the first PDCP entity is received via the at least one RLC entity of the reserved cell group after an end of the first time window set.

Specifically, according to one aspect of the present application, a data unit of the first PDCP entity is transmitted via the at least one RLC entity of the target cell group after an end of the first time window set.

Specifically, according to one aspect of the present application, a MAC entity of the first cell group and a MAC entity of the second cell group are maintained within the first time window set.

Specifically, according to one aspect of the present application, the first node is a UE.

Specifically, according to one aspect of the present application, the first node is a terminal of Internet of Things (IoT).

Specifically, according to one aspect of the present application, the first node is a relay.

Specifically, according to one aspect of the present application, the first node is a vehicle-mounted terminal.

Specifically, according to one aspect of the present application, the first node is an aircraft.

The present application provides a method in a second node for wireless communications, comprising:
transmitting a first signaling and a second signaling; the first signaling configuring at least one Radio Link Control (RLC) entity of a first cell group, while the second signaling configuring at least one RLC entity of a second cell group; and
receiving a first message, the first message requesting a stop of transmission for a target cell group within a first time window set; the first time window set at least comprising one time window;
herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

Specifically, according to one aspect of the present application, a transmitter of the first message receives a second message on a third cell group within the first time window set; or, transmits a third message on a third cell group within the first time window set;
herein, frequency-domain resources occupied by the third cell group are used to determine the target cell group from the first cell group and the second cell group.

Specifically, according to one aspect of the present application, a fourth message is transmitted;
herein, the fourth message is used for acknowledging a request of the first message.

Specifically, according to one aspect of the present application, a fifth message is received on the target cell group within the first time window set;
herein, the fifth message indicates the link failure of the reserved cell group, where the reserved cell group is a cell group other than the target cell group between the first cell group and the second cell group.

Specifically, according to one aspect of the present application, a data unit of a first PDCP entity is transmitted via the at least one RLC entity of the target cell group, where the action of transmitting a data unit of the first PDCP entity via the at least one RLC entity of the target cell group is performed before the action of receiving the first message; a data unit of the first PDCP entity is transmitted via the at least one RLC entity of a reserved cell group in the first time window set, where the reserved cell group is a cell group other than the target cell group between the first cell group and the second cell group;
herein, the first message is used for triggering a transmission of a data unit of the first PDCP entity via the at least one RLC entity of the reserved cell group in the first time window set.

Specifically, according to one aspect of the present application, a data unit of a first PDCP entity is received via the at least one RLC entity of the target cell group before the action of transmitting the first message; and a data unit of the first PDCP entity is received via the at least one RLC entity of a reserved cell group in the first time window, where the reserved cell group is a cell group other than the target cell group between the first cell group and the second cell group;
herein, the first message is used for triggering a reception of a data unit of the first PDCP entity via the at least one RLC entity of the reserved cell group in the first time window.

Specifically, according to one aspect of the present application, a data unit of the first PDCP entity is transmitted via the at least one RLC entity of the reserved cell group after an end of the first time window set.

Specifically, according to one aspect of the present application, a data unit of the first PDCP entity is received via the at least one RLC entity of the target cell group after an end of the first time window set.

Specifically, according to one aspect of the present application, a transmitter of the first message maintains a MAC entity of the first cell group and a MAC entity of the second cell group within the first time window set.

Specifically, according to one aspect of the present application, the second node is a UE.

Specifically, according to one aspect of the present application, the second node is a terminal of Internet of Things (IoT).

Specifically, according to one aspect of the present application, the second node is a satellite.

Specifically, according to one aspect of the present application, the second node is a relay.

Specifically, according to one aspect of the present application, the second node is a vehicle-mounted terminal.

Specifically, according to one aspect of the present application, the second node is an aircraft.

Specifically, according to one aspect of the present application, the second node is a base station.

Specifically, according to one aspect of the present application, the second node is a cell or cell group.

Specifically, according to one aspect of the present application, the second node is a gateway.

Specifically, according to one aspect of the present application, the second node is an access-point.

The present application provides a first node for wireless communications, comprising:
a first receiver, receiving a first signaling and a second signaling; the first signaling configuring at least one Radio Link Control (RLC) entity of a first cell group, while the second signaling configuring at least one RLC entity of a second cell group; and
a first transmitter, transmitting a first message, the first message requesting a stop of transmission for a target cell group within a first time window set; the first time window set at least comprising one time window;
herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

The present application provides a second node for wireless communications, comprising:
a second transmitter, transmitting a first signaling and a second signaling; and the first signaling configuring at least one Radio Link Control (RLC) entity of a first cell group, while the second signaling configuring at least one RLC entity of a second cell group; and
a second receiver, receiving a first message, the first message requesting a stop of transmission for a target cell group within a first time window set; the first time window set at least comprising one time window;
herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, compared with the prior art, the present application is advantageous in the following aspects:

Firstly, the method proposed by the present application can prevent the UE in dual connection with two networks from the situation in which its communication with one network will result in interruption of its connection with the other network; in this way the UE's RRC connection with the previous network can be kept constantly, so will the bearer for previous network configurations. When the UE comes back to the original network, it can continue communication with the network, with almost no delay, which better ensures the QoS of communications of the original network.

Secondly, for a UE supporting multi-connectivity and multicarriers, one can determine whether it is necessary to cut off the current network or it is okay to adjust different cell groups to support the UE when it leaves for the purpose of communication with another network, in accordance with the cases of carriers supported by the UE, thus ensuring the communication performance of the UE to the greatest extent.

Thirdly, the method proposed by the present application can control the UE to assist the network in suspending communication with a cell group when it is not required to communicate with the cell group, which serves the purpose of saving energy, and can also help the UE receive other traffics such as MBMS/MBS, and, if necessary, can enable the UE to continue/resume communication with the cell group with which the communication has been suspended.

Furthermore, since the method proposed by the present application is not very complex, and is convenient and reliable for UE implementation, thus ensuring that the UE can leave at any time necessary.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of receiving a first signaling and a second signaling and transmitting a first message according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of radio signal transmission according to one embodiment of the present application.

FIG. 6 illustrates a flowchart of radio signal transmission according to one embodiment of the present application.

FIG. 7 illustrates a flowchart of radio signal transmission according to one embodiment of the present application.

FIG. 8 illustrates a schematic diagram of a first time window set according to one embodiment of the present application.

FIG. 9 illustrates a schematic diagram of a first time window set according to one embodiment of the present application.

FIG. 10 illustrates a schematic diagram of the network according to one embodiment of the present application.

FIG. 11 illustrates a schematic diagram of an RLC entity according to one embodiment of the present application.

FIG. 12 illustrates a schematic diagram of frequency-domain resources occupied by a third cell group being used to determine a target cell group from a first cell group and a second cell group according to one embodiment of the present application.

FIG. 13 illustrates a structure block diagram of a processing device in a first node according to one embodiment of the present application.

FIG. 14 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

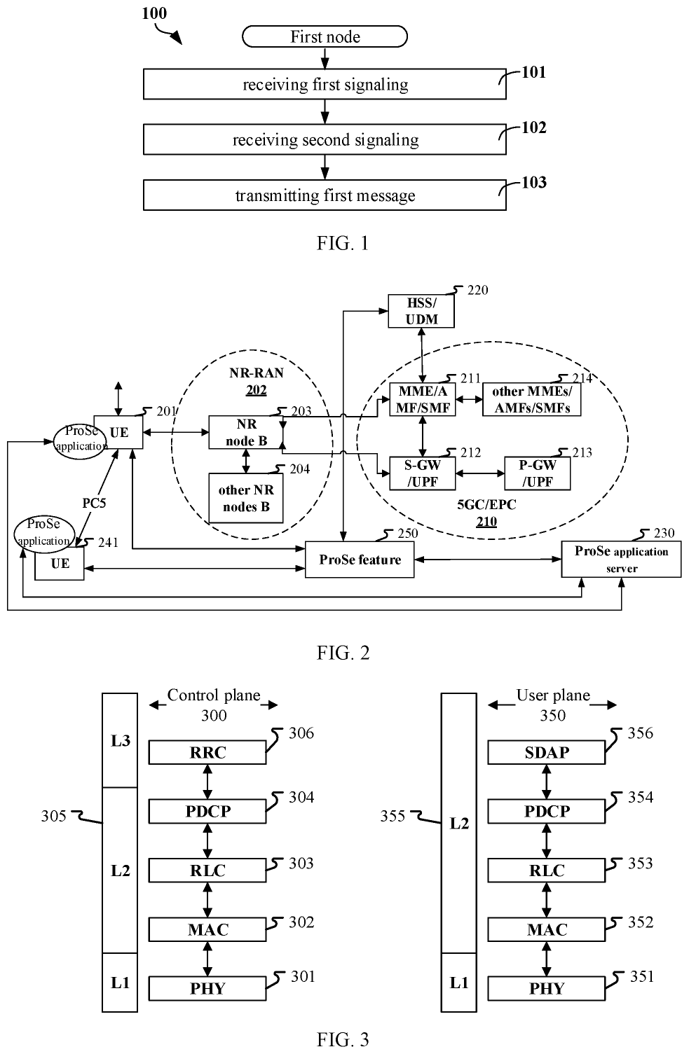

Embodiment 1 illustrates a flowchart of receiving a first signaling and a second signaling and transmitting a first message according to one embodiment of the present application, as shown in FIG. 1. In FIG. 1, each step represents a step, it should be particularly noted that the sequence order of each box herein does not imply a chronological order of steps marked respectively by these boxes.

In Embodiment 1, the first node in the present application receives a first signaling in step 101; and receives a second signaling in step 102; and transmits a first message in step 103;
herein, the first signaling configuring at least one Radio Link Control (RLC) entity of a first cell group, while the second signaling configuring at least one RLC entity of a second cell group; and the first message requests a stop of transmission for a target cell group within a first time window set; the first time window set at least comprising one time window; the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the first node is a UE.

In one embodiment, the first signaling comprises an RRC message.

In one embodiment, the first signaling comprises a NAS message.

In one embodiment, the first signaling comprises a PC5-RRC message.

In one embodiment, the first signaling comprises a PC5-S message.

In one embodiment, the first signaling comprises a SIB.

In one embodiment, the first signaling comprises a RRCReconfiguration.

In one embodiment, the first signaling comprises a RRCReconfigurationSidelink.

In one embodiment, the first signaling comprises a RRCConnectionReconfiguration.

In one embodiment, the first signaling comprises a RRCConnectionReconfigurationSidelink.

In one embodiment, the first signaling comprises a SpCellConfig.

In one embodiment, the first signaling is a RRCReconfiguration.

In one embodiment, the first signaling is a RRCReconfigurationSidelink.

In one embodiment, the first signaling is transmitted in a broadcast way.

In one embodiment, the first signaling is transmitted in a unicast way.

In one embodiment, the first signaling comprises a drx-config.

In one embodiment, the first signaling comprises a sl-drx-config.

In one embodiment, the first signaling comprises a drx-configsidelink.

In one embodiment, the first signaling comprises a MRDC-SecondaryCellGroupConfig.

In one embodiment, the first signaling comprises a MAC Control Element (CE).

In one embodiment, the first signaling is downlink control information (DCI.

In one embodiment, the first signaling is a short message in a DCI.

In one embodiment, the first signaling is a MAC CE.

In one embodiment, the first signaling comprises a DRX Command MAC CE.

In one embodiment, the first signaling comprises a Long DRX Command MAC CE.

In one embodiment, the first signaling is a MAC CE, the MAC CE having only 0 bit, and a MAC subheader corresponding to the MAC CE comprising N bits;

In one subembodiment, N is equal to 8;

In one subembodiment, N is equal to 16;

In one subembodiment, the MAC subheader corresponding to the first signaling comprises an R field and a LCID field;

In one subembodiment, the value of the LCID field is 59;

In one subembodiment, the value of the LCID field is 60;

In one subembodiment, the value of the LCID field is a number other than 59 and 60;

In one subembodiment, the value of the LCID field is neither 59 nor 60;

In one subembodiment, the value of the LCID field is a positive integer between 35 and 46.

In one embodiment, the second signaling comprises an RRC message.

In one embodiment, the second signaling comprises a NAS message.

In one embodiment, the second signaling comprises a PC5-RRC message.

In one embodiment, the second signaling comprises a PC5-S message.

In one embodiment, the second signaling comprises a SIB.

In one embodiment, the second signaling comprises a RRCReconfiguration.

In one embodiment, the second signaling comprises a RRCReconfigurationSidelink.

In one embodiment, the second signaling comprises a RRCConnectionReconfiguration.

In one embodiment, the second signaling comprises a RRCConnectionReconfigurationSidelink.

In one embodiment, the second signaling comprises a SpCellConfig.

In one embodiment, the second signaling is a RRCReconfiguration.

In one embodiment, the second signaling is a RRCReconfigurationSidelink.

In one embodiment, the second signaling is transmitted in a broadcast way.

In one embodiment, the second signaling is transmitted in a unicast way.

In one embodiment, the second signaling comprises a drx-config.

In one embodiment, the second signaling comprises a sl-drx-config.

In one embodiment, the second signaling comprises a drx-configsidelink.

In one embodiment, the second signaling comprises a cellgroupconfig.

In one embodiment, the second signaling comprises a MRDC-SecondaryCellGroupConfig.

In one embodiment, the first signaling and the second signaling are multiplexed in a same RRC message.

In one embodiment, the first signaling comprises the second signaling.

In one embodiment, the first message is transmitted via a Uu interface.

In one embodiment, the first message comprises an RRC message.

In one embodiment, the first message comprises an Uplink Control Information (UCI) message.

In one embodiment, a physical channel occupied by the first message includes a Physical Uplink Shared Channel (PUSCH).

In one embodiment, a logical channel occupied by the first message includes a Dedicated Control Channel (DCCH).

In one embodiment, the first message is transmitted using an SRB1 or SRB3.

In one embodiment, the first message comprises at least partial fields in UEAssistancelnformation.

In one embodiment, the first message comprises a UELeavingRequest.

In one embodiment, the first message comprises a UESwitchingRequest.

In one embodiment, the first message comprises a UEShortLeavingRequest.

In one embodiment, the first message comprises a UEAvailablilitylndication.

In one embodiment, the first message comprises a UElnavailablilitylndication.

In one embodiment, the first message comprises a RRCReconfigurationSidelink.

In one embodiment, the first message comprises MCGFailurelnformation.

In one embodiment, the first message comprises SCGFailurelnformation.

In one embodiment, the first message comprises a ULInformationTransfer.

In one embodiment, the first message is transmitted via a PC5 interface.

In one embodiment, the first message comprises a PC5-RRC message.

In one embodiment, the first message comprises a PC5-S message.

In one embodiment, the first message comprises a period of the first time window set.

In one embodiment, the first message comprises lengths of time windows in the first time window set.

In one embodiment, the first message comprises a start of the first time window set.

In one embodiment, the first message comprises a number of time windows in the first time window set.

In one embodiment, the first message indicates a preferred DRX cycle;

In one subembodiment, the preferred DRX cycle is a DRX cycle preferred within the first time window set;

In one subembodiment, the DRX cycle is one of the first time length or the second time length.

In one embodiment, the first message indicates that the second time length is not used within the first time window set to determine a start time of the second timer;

In one subembodiment, the DRX cycle is a Short DRX cycle;

In one subembodiment, the DRX cycle is a Long DRX cycle.

In one embodiment, the first message indicates whether it is the second time length or the first time length that is used within the first time window set to determine a start time of the second timer.

In one embodiment, the first node has two SIMs that connect to two networks;

In one subembodiment, the two networks are respectively an LTE network and an NR network;

In one subembodiment, the two networks are respectively an NR network and another NR network;

In one subembodiment, the two networks are respectively a non-3GPP network and a 3GPP network;

In one subembodiment, the two networks are respectively a V2X network and an NR network.

In one embodiment, the first node possesses two SIMs, of which one SIM is for the transmitter of the first signaling; the other is for a second network, the second network being a network other than the transmitter of the first signaling.

In one embodiment, the first node possesses two SIMs, of which one SIM is for a Public Land Mobile Network (PLMN) of the transmitter of the first signaling; the other is for a second network, the second network being a PLMN other than the transmitter of the first signaling.

In one embodiment, the first node possesses two SIMs, of which one SIM is for a network to which the first cell set belongs; the other is for a second network, the second network being a network other than the network to which the first cell set belongs.

In one embodiment, the SIM comprises a Universal Subscriber Identity Module (USIM).

In one embodiment, the SIM comprises an eSIM.

In one embodiment, the SIM comprises a Universal Integrated Circuit Card (UICC).

In one embodiment, the SIM comprises a variety of sizes.

In one embodiment, the SIM is for at least one of {LTE network, 3G network, 4G network, 5G network, 6G network, TN, NTN, URLLC network, IoT network, vehicle-mounted network, IIoT network, broadcast network, unicast network, 3GPP network, Non-3GPP network}.

In one embodiment, the first node has one transmitter and one receiver.

In one embodiment, the first node has one transmitter and two receivers.

In one embodiment, the first node has two transmitters and two receivers.

In one embodiment, there exists an RRC connection between the first node and a transmitter of the first signaling, or the first node is in an RRC connected state relative to the transmitter of the first signaling.

In one embodiment, there exists an RRC connection between the first node and a cell group to which the first cell set belongs.

In one embodiment, there exists an RRC connection between the first node and a PCell in the first cell set.

In one embodiment, the first node is in an RRC Connected state relative to the second network.

In one embodiment, the first node is in an RRC Idle state relative to the second network.

In one embodiment, the first node is in an RRC Inactive state relative to the second network.

In one embodiment, when the first condition set is satisfied, monitoring the target channel is canceled in an active time within the first time window set.

In one embodiment, the first node supports interBandContiguousMRDC.

In one embodiment, the first node supports intraBandENDC-Support.

In one embodiment, the first node supports uplinkTxSwitching-OptionSupport-r16 for dualUL.

In one embodiment, the first node supports uplinkTxSwitching-OptionSupport-r16 for switchedUL.

In one embodiment, the first node supports MRDC.

In one embodiment, the first node supports NRDC.

In one embodiment, the first time window set comprises W time window(s), where W is a positive integer.

In one embodiment, time windows comprised in the first time window set are of equal lengths.

In one embodiment, time windows comprised in the first time window set are of unequal lengths.

In one embodiment, time windows comprised in the first time window set are orthogonal in time domain.

In one embodiment, time windows comprised in the first time window set are arranged in order in time domain.

In one embodiment, a time interval between any two time windows comprised in the first time window set is no smaller than time occupied by an OFDM symbol.

In one embodiment, time intervals between any two pairs of adjacent time windows comprised in the first time window set which are adjacent in time domain are mutually equal.

In one embodiment, time intervals between any two pairs of adjacent time windows comprised in the first time window set which are adjacent in time domain are mutually unequal.

In one embodiment, the first time window set comprises multiple time windows that occur periodically in time domain.

In one embodiment, the first time window set only comprises one time window.

In one embodiment, each of the first cell group and the second cell group respectively comprises a positive integer number of cell(s).

In one embodiment, each cell comprised by the first cell group is a serving cell of the first node.

In one embodiment, each cell comprised by the second cell group is a serving cell of the first node.

In one embodiment, the first cell group is a cellgroup.

In one embodiment, the second cell group is a cellgroup.

In one embodiment, the first cell group comprises or only comprises a transmitter of the first signaling.

In one embodiment, the first cell group does not comprise a transmitter of the first signaling.

In one embodiment, the first cell group comprises a PCell of the first node.

In one embodiment, the first cell group comprises a SpCell of the first node.

In one embodiment, the first cell group comprises an MCG of the first node.

In one embodiment, the first cell group comprises an SCG of the first node.

In one embodiment, the first cell group only comprises cell(s) in an MCG of the first node.

In one embodiment, the first cell group only comprises cell(s) in an SCG of the first node.

In one embodiment, cells comprised by the first cell group belong to a same PLMN.

In one embodiment, cells comprised by the first cell group belong to a same wireless network.

In one embodiment, cells comprised by the first cell group belong to part of cells in an MCG.

In one embodiment, cells comprised by the first cell group belong to part of cells in an SCG.

In one embodiment, cells comprised by the first cell group belong to a network determined by a SIM of the first node.

In one embodiment, the first node has an RRC connection with at least one cell in the first cell group.

In one embodiment, the first node has an RRC connection with the first cell group.

In one embodiment, the first node has an RRC connection with an access network determined by the first cell group.

In one embodiment, the first cell group comprises part of cells in an MCG and an SCG of the first node.

In one embodiment, the first cell group comprises all cells in an MCG and an SCG of the first node.

In one embodiment, the first cell group comprises all or part of cells in an MCG and an SCG determined by a SIM of the first node.

In one embodiment, the first cell group comprises all or part of cells in an MCG and an SCG of a PLMN corresponding to a SIM of the first node.

In one embodiment, the first cell group is a cell group of the first node.

In one embodiment, each cell comprised by the first cell group is a TN cell.

In one embodiment, each cell comprised by the first cell group is an NTN cell.

In one embodiment, cells in the first cell group belong to a same DRX group.

In one embodiment, the second cell group comprises or only comprises a transmitter of the first signaling.

In one embodiment, the second cell group does not comprise a transmitter of the first signaling.

In one embodiment, the second cell group comprises a PCell of the first node.

In one embodiment, the second cell group comprises a SpCell of the first node.

In one embodiment, the second cell group comprises an MCG of the first node.

In one embodiment, the second cell group comprises an SCG of the first node.

In one embodiment, the second cell group only comprises cell(s) in an MCG of the first node.

In one embodiment, the second cell group only comprises cell(s) in an SCG of the first node.

In one embodiment, cells comprised by the second cell group belong to a same PLMN.

In one embodiment, cells comprised by the second cell group belong to a same wireless network.

In one embodiment, cells comprised by the second cell group belong to part of cells in an MCG.

In one embodiment, cells comprised by the second cell group belong to part of cells in an SCG.

In one embodiment, cells comprised by the second cell group belong to a network determined by a SIM of the first node.

In one embodiment, the first node has an RRC connection with at least one cell in the second cell group.

In one embodiment, the first node has an RRC connection with the second cell group.

In one embodiment, the first node has an RRC connection with an access network determined by the second cell group.

In one embodiment, the second cell group comprises part of cells in an MCG and an SCG of the first node.

In one embodiment, the second cell group comprises all cells in an MCG and an SCG of the first node.

In one embodiment, the second cell group comprises all or part of cells in an MCG and an SCG determined by a SIM of the first node.

In one embodiment, the second cell group comprises all or part of cells in an MCG and an SCG of a PLMN corresponding to a SIM of the first node.

In one embodiment, the second cell group is a cell group of the first node.

In one embodiment, each cell comprised by the second cell group is a TN cell.

In one embodiment, each cell comprised by the second cell group is an NTN cell.

In one embodiment, cells in the second cell group belong to a same DRX group.

In one embodiment, the first cell group and the second cell group belong to a same PLMN.

In one embodiment, the first cell group is an MCG of the first node, while the second cell group is an SCG of the first node.

In one embodiment, the first cell group is an SCG of the first node, while the second cell group is an MCG of the first node.

In one embodiment, the first cell group is an SCG of the first node, while the second cell group is an SCG of the first node.

In one embodiment, the first cell group and the second cell group correspond to a same SIM.

In one embodiment, the sentence that the first message requests a stop of transmission for a target cell group within a first time window set comprises that: there isn't any cell in the target cell group that will perform uplink and/or downlink scheduling for the first node within the first time window set.

In one embodiment, the sentence that the first message requests a stop of transmission for a target cell group within a first time window set comprises that: an MCG of the first node won't perform uplink and/or downlink scheduling for the first node in the target cell group and/or any cell in the target cell group within the first time window set.

In one embodiment, the sentence that the first message requests a stop of transmission for a target cell group within a first time window set comprises that: a scrambling used by a radio signal transmitted by the first node within the first time window set is assigned by a node other than the target cell group.

In one embodiment, the sentence that the first message requests a stop of transmission for a target cell group within a first time window set comprises that: an MCG to which the target cell group belongs won't perform uplink and/or downlink scheduling for the first node within the first time window set.

In one embodiment, the sentence that the first message requests a stop of transmission for a target cell group within a first time window set comprises that: the first node will not be performed uplink and/or downlink scheduling by the target cell group within the first time window set.

In one embodiment, the sentence that the first message requests a stop of transmission for a target cell group within a first time window set comprises that: the first node is incapable to or will not or fails to or drops the action to transmit any radio signal to the target cell group within the first time window set.

In one embodiment, the sentence that the first message requests a stop of transmission for a target cell group within a first time window set comprises that: the first node assumes that the time comprised in the first time window set is not an Active Time of the target cell group.

In one embodiment, the sentence that the first message requests a stop of transmission for a target cell group within a first time window set comprises that: the first node assumes that the time comprised in the first time window set is not an Active Time of any cell in the target cell group.

In one embodiment, the sentence that the first message requests a stop of transmission for a target cell group within a first time window set comprises that: the first node is incapable to or will not or fails to receive a radio signal transmitted by the target cell group within the first time window set.

In one embodiment, the first message indicates that the first node can only receive a second-type target signal transmitted by the target cell group within the first time window set.

In one embodiment, the second-type target signal comprises a radio signal bearing broadcast traffics.

In one embodiment, the second-type target signal comprises a radio signal bearing groupcast traffics.

In one embodiment, the second-type target signal comprises a radio signal bearing DCI.

In one embodiment, the second-type target signal comprises a radio signal bearing part of a DCI Format.

In one embodiment, the second-type target signal comprises a paging message.

In one embodiment, the second-type target signal comprises a RRCRelease.

In one embodiment, the second-type target signal comprises a RRCConnectionRelease.

In one embodiment, the second-type target signal comprises a SIB.

In one embodiment, the second-type target signal comprises an Earthquake and Tsunami Warning System (ETWS) signal.

In one embodiment, the second-type target signal comprises any radio signal transmitted by the target cell group.

In one embodiment, the second-type target signal comprises any radio signal transmitted by the target cell group that is associated with a specific CSI-RS.

In one embodiment, the first node determines the specific CSI-RS according to a candidate CSI-RS indicated by the target cell group.

In one embodiment, the second-type target signal comprises any radio signal transmitted by the target cell group that is associated with a specific SSB.

In one embodiment, the first node determines the specific SSB according to a candidate SSB indicated by the target cell group.

In one embodiment, cells in the first cell group and cells in the second cell group respectively belong to different DRX groups.

In one embodiment, cells in the target cell group are assumed to be in a non-Active Time within the first time window set.

In one embodiment, a serving cell of the first node indicates that cells in the target cell group are in a non-Active Time within the first time window set.

In one embodiment, the sentence that the first message requests a stop of transmission for a target cell group within a first time window set comprises the following meaning: the first message explicitly requests a stop of transmission for a target cell group within a first time window set.

In one embodiment, the first signaling comprises an RLC-BearerConfig, the RLC-BearerConfig being used for configuring the at least one said RLC entity of the first cell group.

In one embodiment, the first signaling comprises an RLC-Config, the RLC-Config being used for configuring the at least one said RLC entity of the first cell group.

In one embodiment, the first signaling comprises a mac-LogicalChannelConfig, the mac-LogicalChannelConfig being used for configuring the at least one said RLC entity of the first cell group.

In one embodiment, the at least one RLC entity of the first cell group corresponds to one RLC bearer.

In one embodiment, the second signaling comprises an RLC-BearerConfig, the RLC-BearerConfig being used for configuring the at least one said RLC entity of the second cell group.

In one embodiment, the second signaling comprises an RLC-Config, the RLC-Config being used for configuring the at least one said RLC entity of the second cell group.

In one embodiment, the second signaling comprises a mac-LogicalChannelConfig, the mac-LogicalChannelConfig being used for configuring the at least one said RLC entity of the second cell group.

In one embodiment, the at least one RLC entity of the second cell group corresponds to one RLC bearer.

In one embodiment, the first message requests a stop of reception for at least one cell in the target cell group within the first time window set.

In one embodiment, there exists no cell that belongs to the first cell group and the second cell group simultaneously.

In one embodiment, an RLC entity being maintained includes that the RLC entity is not Removed.

In one embodiment, an RLC entity being maintained includes that the RLC entity is not Released.

In one embodiment, an RLC entity being maintained includes that the RLC entity is not Re-established.

In one embodiment, an RLC entity being maintained includes that a state variable of the RLC entity is reserved or retained.

In one embodiment, an RLC entity being maintained includes that a logical channel corresponding to the RLC entity is reserved.

In one embodiment, an RLC entity being maintained includes that an identity of a logical channel corresponding to the RLC entity is reserved or continues to be occupied.

In one embodiment, an RLC entity being maintained includes that RLC SDUs, RLC SDU segments or an RLC PDU in the RLC entity are reserved.

In one embodiment, an RLC entity being maintained includes that RLC SDUs, RLC SDU segments or an RLC PDU in the RLC entity are reserved.

In one subembodiment, an RLC entity being maintained includes that at least one timer of the RLC entity is terminated or reset.

In one subembodiment, an RLC entity being maintained includes that at least one state variable of the RLC entity is reset to an initial value.

In one subembodiment, one of the first signaling or the second signaling is used for configuring a first PDCP entity, the first PDCP entity being configured to be associated with N RLC entities of the target cell group; the at least one RLC entity of the target cell group belongs to the N RLC entities of the target cell group, where N is a positive integer greater than 2; the first PDCP entity is configured with PDCP repetition, and within the first time window set, the at least one RLC entity of the target cell group is associated with the first PDCP entity.

In one subembodiment, an RLC entity associated with the first PDCP entity within the first time window set is identical to an RLC entity associated with the first PDCP entity before the first time window set.

In one subembodiment, the at least one RLC entity of the target cell group is used for processing or bearing a data unit of the first PDCP entity; an RLC bearer corresponding to the at least one RLC entity of the target cell group is used for bearing a data unit of the first PDCP entity.

In one embodiment, the first signaling comprises a cell identifier of each cell in the first cell group, while the second signaling comprises a cell identifier of each cell in the second cell group.

In one embodiment, the cell identifier includes a serving cell index.

In one embodiment, the cell identifier includes a physical cell index.

In one embodiment, both of the at least one RLC entity of the first cell group and the at least one RLC entity of the second cell group are maintained in a time window that follows the first time window set.

In one embodiment, the first node receives a second message on a third cell group within the first time window set.

In one embodiment, the first node transmits a third message on a third cell group within the first time window set.

In one embodiment, the first node performs a first operation for a first timer of the target cell group within the first time window set;

In one subembodiment, the first operation includes restarting;

In one subembodiment, the first operation includes stopping;

In one subembodiment, the first operation includes deleting;

In one subembodiment, the first operation includes releasing;

In one subembodiment, the first operation includes ignoring an expiration of the first timer, i. e., the expiration of the first timer does not trigger any action of the first node;

In one subembodiment, the first timer includes a T316;

In one subembodiment, the first timer includes a bwp-InactivityTimer;

In one subembodiment, the first timer includes a datalnactivityTimer;

In one subembodiment, the first timer includes a sCellDeactivationTimer.

In one embodiment, the first node performs a second operation for a second timer of at least one cell in the target cell group within the first time window;

In one subembodiment, the second operation includes restarting;

In one subembodiment, the second operation includes stopping;

In one subembodiment, the second operation includes deleting;

In one subembodiment, the second operation includes releasing;

In one subembodiment, the second operation includes ignoring an expiration of the first timer, i.e., the expiration of the first timer does not trigger any action of the first node;

In one subembodiment, the second timer includes a bwp-InactivityTimer;

In one subembodiment, the second timer includes a dataInactivityTimer;

In one subembodiment, the second timer includes a sCellDeactivationTimer.

In one embodiment, the first node maintains a MAC entity of the first cell group within the first time window set;

In one subembodiment, the first node establishes the MAC entity of the first cell group before the first time window set;

In one subembodiment, the first cell group only has one MAC entity;

In one subembodiment, the first signaling configures the MAC entity of the first cell group;

In one subembodiment, the MAC entity of the first cell group bears a data unit of the at least one RLC entity of the first cell group;

In one subembodiment, the action of maintaining a MAC entity of the first cell group comprises that: the MAC entity of the first cell group is not reset;

In one subembodiment, the action of maintaining a MAC entity of the first cell group comprises that: the MAC entity of the first cell group is not released;

In one subembodiment, the action of maintaining a MAC entity of the first cell group comprises that: the MAC entity of the first cell group is not removed;

In one subembodiment, the action of maintaining a MAC entity of the first cell group comprises that: at least one state variable of the MAC entity of the first cell group is not modified or reserved;

In one subembodiment, the action of maintaining a MAC entity of the first cell group comprises that: at least one timer of the MAC entity of the first cell group is not restarted or stopped;

In one subembodiment, the action of maintaining a MAC entity of the first cell group comprises that: at least one state variable of the MAC entity of the first cell group is modified or reset to an initial value;

In one subembodiment, the action of maintaining a MAC entity of the first cell group comprises that: at least one timer of the MAC entity of the first cell group is restarted or stopped.

In one embodiment, the first node maintains a MAC entity of the second cell group within the first time window set;

In one subembodiment, the first node establishes the MAC entity of the second cell group before the first time window set;

In one subembodiment, the second cell group only has one MAC entity;

In one subembodiment, the first signaling configures the MAC entity of the second cell group;

In one subembodiment, the MAC entity of the second cell group bears a data unit of the at least one RLC entity of the second cell group;

In one subembodiment, the action of maintaining a MAC entity of the second cell group comprises that: the MAC entity of the second cell group is not reset;

In one subembodiment, the action of maintaining a MAC entity of the second cell group comprises that: the MAC entity of the second cell group is not released;

In one subembodiment, the action of maintaining a MAC entity of the second cell group comprises that: the MAC entity of the second cell group is not removed;

In one subembodiment, the action of maintaining a MAC entity of the second cell group comprises that: at least one state variable of the MAC entity of the second cell group is not modified or reserved;

In one subembodiment, the action of maintaining a MAC entity of the second cell group comprises that: at least one timer of the MAC entity of the second cell group is not restarted or stopped;

In one subembodiment, the action of maintaining a MAC entity of the second cell group comprises that: at least one state variable of the MAC entity of the second cell group is modified or reset to an initial value;

In one subembodiment, the action of maintaining a MAC entity of the second cell group comprises that: at least one timer of the MAC entity of the second cell group is restarted or stopped.

In one embodiment, the MAC entity of the first cell group continues to be used after an end of the first time window set.

In one embodiment, the MAC entity of the second cell group continues to be used after an end of the first time window set.

In one embodiment, the first signaling explicitly configures the first cell group.

In one embodiment, the second signaling explicitly configures the second cell group.

In one embodiment, the target cell group is in a deactivated state within the first time window set.

In one embodiment, the first message comprises an identity of the target cell group.

In one embodiment, the first message comprises an index of the target cell group.

In one embodiment, the first message comprises a first cell list, where each cell in the first cell list belongs to the target cell group.

In one embodiment, the first message indicates that the first node enters into or needs to enter into power-saving mode in the first time window set.

In one embodiment, the first message indicates that the first node receives or is interested in receiving first service;

In one subembodiment, the first service is non-unicast service;

In one subembodiment, the first service is MBS service;

In one subembodiment, the first service is Multimedia Broadcast Multicast Service (MBMS);

In one subembodiment, the first service occupies a Bandwidth Part (BWP) other than a current Active BWP;

In one subembodiment, the first service uses a radio access technology (RAT) other than the first cell group and the second cell group;

In one subembodiment, a reception of the first service cannot be performed concurrently with a reception and/or transmission of the target cell group.

In one embodiment, the first message indicates that the first node receives or is interested in receiving second service;

In one subembodiment, the second service is received and/or transmitted via sidelink;

In one subembodiment, the second service occupies a PC5 interface;

In one subembodiment, the second service uses a mode1 resource pool;

In one subembodiment, the second service uses a mode2 resource pool;

In one subembodiment, the second service uses a resource pool other than a mode1 resource pool and a mode2 resource pool;

In one subembodiment, the second service uses relaying;

In one subembodiment, the second service uses time-frequency resources other than the first cell group and the second cell group;

In one subembodiment, the second service uses time-frequency resources of a network other than the network to which the first cell group and the second cell group belong;

In one subembodiment, a reception of the second service cannot be performed concurrently with a reception and/or transmission of the target cell group.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called System/Evolved Packet System (5GS/EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server/Unified Data Management(HSS/UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201-oriented user plane and control plane terminations. The gNB 203 may be connected to other gNBs 204 via an Xn interface (for example, backhaul). The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the 5GC/EPC 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected with the 5G-CN/EPC 210 via an S1/NG interface. The 5G-CN/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212. The S-GW/UPF 212 is connected to the P-GW/UPF 213. The P-GW 213 provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 supports transmissions in NTN.

In one embodiment, the UE 201 supports transmissions in large-delay-difference networks.

In one embodiment, the UE 201 supports V2X transmission.

In one embodiment, the UE 201 supports multiple SIMs.

In one embodiment, the UE 201 supports sidelink transmission.

In one embodiment, the UE 201 supports MBS transmission.

In one embodiment, the UE 201 supports MBMS transmission.

In one embodiment, the gNB203 corresponds to the second node in the present application.

In one embodiment, the gNB203 supports transmissions in NTN.

In one embodiment, the gNB203 supports transmissions in large-delay-difference networks.

In one embodiment, the gNB203 supports V2X transmission.

In one embodiment, the gNB203 supports sidelink transmission.

In one embodiment, the gNB203 supports MBS transmission.

In one embodiment, the gNB203 supports MBMS transmission.

In one embodiment, the gNB203 supports communication with multi-SIM UE.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first node (UE, gNB or, satellite or aircraft in NTN) and a second node (gNB, UE, or satellite or aircraft in NTN), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between a first node and a second node as well as between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All these sublayers terminate at the second nodes. The PDCP sublayer 304 provides multiplexing among variable radio bearers and logical channels. The PDCP sublayer 304 provides security by encrypting packets and also support for inter-cell handover of the first node between nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first nodes various radio resources (i.e., resource block) in a cell. The MAC sublayer 302 is also in charge of HARQ operation. In the control plane 300, the RRC sublayer 306 in the L3 layer is responsible for acquiring radio resources (i.e., radio bearer) and configuring the lower layer using an RRC signaling between the second node and the first node. The radio protocol architecture in the user plane 350 comprises the L1 layer and the L2 layer. In the user plane 350, the radio protocol architecture used for the first node and the second node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first node may comprise several higher layers above the L2 355. Besides, the first node comprises a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first message in the present application is generated by the PHY301, or the PHY351, or the MAC302, or the MAC352, or the RRC306.

In one embodiment, the second message in the present application is generated by the PHY301, or the PHY351, or the MAC302, or the MAC352, or the RRC306.

In one embodiment, the third message in the present application is generated by the PHY301, or the PHY351, or the MAC302, or the MAC352, or the RRC306.

In one embodiment, the fourth message in the present application is generated by the PHY301, or the PHY351, or the MAC302, or the MAC352, or the RRC306.

In one embodiment, the fifth message in the present application is generated by the PHY301, or the PHY351, or the MAC302, or the MAC352, or the RRC306.

In one embodiment, the data unit of the first PDCP entity in the present application is generated by the PDCP304 or PDCP354.

In one embodiment, the first signaling in the present application is generated by the PHY301, or the PHY351, or the MAC302, or the MAC352, or the RRC306.

In one embodiment, the second signaling in the present application is generated by the PHY301, or the PHY351, or the MAC302, or the MAC352, or the RRC306.

### Embodiment 4

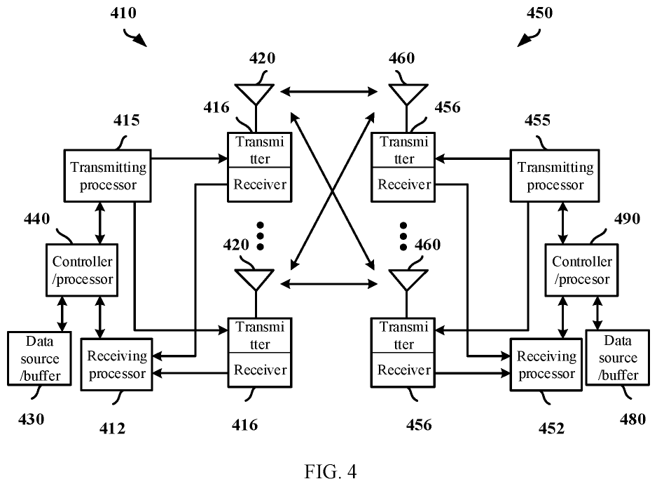

Embodiment 4 illustrates a schematic diagram of a first communication device and a second communication device according to the present application, as shown in FIG. 4. FIG. 4 is a block diagram of a first communication device 450 and a second communication device 410 in communication with each other in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from a core network is provided to the controller/processor 475. The controller/processor 475 provides functions of the L2 layer. In the transmission from the second communication device 410 to the first communication device 450, the controller/processor 475 provides header compression, encryption, packet segmentation and reordering, and multiplexing between a logical channel and a transport channel, and radio resource allocation of the first communication device 450 based on various priorities. The controller/processor 475 is also in charge of HARQ operation, a retransmission of a lost packet and a signaling to the first communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 410 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the second communication device 410 to the first communication device 450, at the first communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the first communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the second communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the second communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the first communication device 450 to the second communication device 410, at the first communication device 450, the data source 467 is configured to provide a higher-layer packet to the controller/processor 459. The data source 467 represents all protocol layers above the L2 layer. Similar to a transmitting function of the second communication device 410 described in the transmission from the second communication node 410 to the first communication node 450, the controller/processor 459 performs header compression, encryption, packet segmentation and reordering, and multiplexing between a logical channel and a transport channel based on radio resource allocation so as to provide the L2 layer functions used for the user plane and the control plane. The controller/processor 459 is also responsible for a retransmission of a lost packet, and a signaling to the second communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 first converts a baseband symbol stream provided by the multi-antenna transmitting processor 457 into a radio frequency symbol stream, and then provides the radio frequency symbol stream to the antenna 452.

In a transmission from the first communication device 450 to the second communication device 410, the function of the second communication device 410 is similar to the receiving function of the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decrypting, header decompression, control signal processing so as to recover a higher-layer packet from the first communication device (UE) 450. The higher-layer packet coming from the controller/processor 475 may be provided to the core network.

In one embodiment, the first communication device 450 comprises at least one processor and at least one memory, the at least one memory comprises computer program codes; the at least one memory and the computer program codes are configured to be used in collaboration with the at least one processor. The first communication device 450 at least: receives a first signaling and a second signaling; the first signaling configuring at least one Radio Link Control (RLC) entity of a first cell group, while the second signaling configuring at least one RLC entity of a second cell group; and transmits a first message, the first message requesting a stop of transmission for a target cell group within a first time window set; the first time window set at least comprises one time window; herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the first communication node 450 comprises a memory that stores a computer readable instruction program, the computer readable instruction program generates actions when executed by at least one processor, which include: receiving a first signaling and a second signaling; the first signaling configuring at least one Radio Link Control (RLC) entity of a first cell group, while the second signaling configuring at least one RLC entity of a second cell group; and transmitting a first message, the first message requesting a stop of transmission for a target cell group within a first time window set; the first time window set at least comprises one time window; herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the second communication device 410 comprises at least one processor and at least one memory, the at least one memory comprises computer program codes; the at least one memory and the computer program codes are configured to be used in collaboration with the at least one processor. The second communication device 410 at least: transmits a first signaling and a second signaling; the first signaling configuring at least one Radio Link Control (RLC) entity of a first cell group, while the second signaling configuring at least one RLC entity of a second cell group; and receives a first message, the first mess age requesting a stop of transmission for a target cell group within a first time window set; the first time window set at least comprising one time window; herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the second communication device 410 comprises a memory that stores a computer readable instruction program, the computer readable instruction program generates actions when executed by at least one processor, which include: transmitting a first signaling and a second signaling; the first signaling configuring at least one Radio Link Control (RLC) entity of a first cell group, while the second signaling configuring at least one RLC entity of a second cell group; and receiving a first message, the first message requesting a stop of transmission for a target cell group within a first time window set; the first time window set at least comprising one time window; herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the first communication device 450 corresponds to the first node in the present application.

In one embodiment, the second communication device 410 corresponds to the second node in the present application.

In one embodiment, the first communication device 450 is a UE.

In one embodiment, the first communication device 450 is a vehicle-mounted terminal.

In one embodiment, the first communication device 450 is a relay.

In one embodiment, the first communication device 450 is a satellite.

In one embodiment, the first communication device 450 is an aircraft.

In one embodiment, the second communication device 410 is a base station.

In one embodiment, the second communication device 410 is a relay.

In one embodiment, the second communication device 410 is a UE.

In one embodiment, the second communication device 410 is a satellite.

In one embodiment, the second communication device 410 is an aircraft.

In one embodiment, the receiver 456 (comprising the antenna 460), the receiving processor 452 and the controller/processor 490 are used for receiving the first signaling in the present application.

In one embodiment, the receiver 456 (comprising the antenna 460), the receiving processor 452 and the controller/processor 490 are used for receiving the second signaling in the present application.

In one embodiment, the receiver 456 (comprising the antenna 460), the receiving processor 452 and the controller/processor 490 are used for receiving the second message in the present application.

In one embodiment, the receiver 456 (comprising the antenna 460), the receiving processor 452 and the controller/processor 490 are used for receiving the fourth message in the present application.

In one embodiment, the receiver 456 (comprising the antenna 460), the receiving processor 452 and the controller/processor 490 are used for receiving a data unit of the first PDCP entity in the present application.

In one embodiment, the transmitter 456 (comprising the antenna 460), the transmitting processor 455 and the controller/processor 490 are used for transmitting the first message in the present application.

In one embodiment, the transmitter 456 (comprising the antenna 460), the transmitting processor 455 and the controller/processor 490 are used for transmitting the third message in the present application.

In one embodiment, the transmitter 456 (comprising the antenna 460), the transmitting processor 455 and the controller/processor 490 are used for transmitting the fifth message in the present application.

In one embodiment, the transmitter 456 (comprising the antenna 460), the transmitting processor 455 and the controller/processor 490 are used for transmitting a data unit of the first PDCP entity in the present application.

In one embodiment, the transmitter 416 (comprising the antenna 420), the transmitting processor 412 and the controller/processor 440 are used for transmitting the first signaling in the present application.

In one embodiment, the transmitter 416 (comprising the antenna 420), the transmitting processor 412 and the controller/processor 440 are used for transmitting the second signaling in the present application.

In one embodiment, the transmitter 416 (comprising the antenna 420), the transmitting processor 412 and the controller/processor 440 are used for transmitting the second message in the present application.

In one embodiment, the transmitter 416 (comprising the antenna 420), the transmitting processor 412 and the controller/processor 440 are used for transmitting the fourth message in the present application.

In one embodiment, the transmitter 416 (comprising the antenna 420), the transmitting processor 412 and the controller/processor 440 are used for transmitting a data unit of the first PDCP entity in the present application.

In one embodiment, the receiver 416 (comprising the antenna 420), the receiving processor 412 and the controller/processor 440 are used for receiving the first message in the present application.

In one embodiment, the receiver 416 (comprising the antenna 420), the receiving processor 412 and the controller/processor 440 are used for receiving the third message in the present application.

In one embodiment, the receiver 416 (comprising the antenna 420), the receiving processor 412 and the controller/processor 440 are used for receiving the fifth message in the present application.

In one embodiment, the receiver 416 (comprising the antenna 420), the receiving processor 412 and the controller/processor 440 are used for receiving a data unit of the first PDCP entity in the present application.

### Embodiment 5

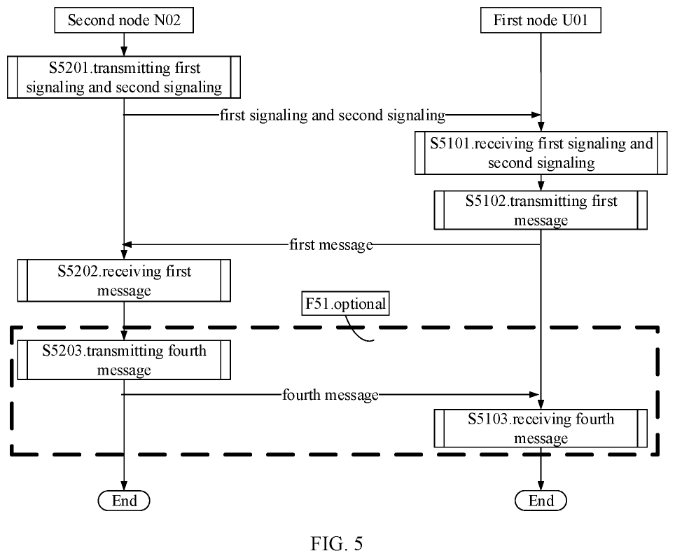

Embodiment 5 illustrates a flowchart of radio signal transmission according to one embodiment of the present application, as shown in FIG. 5. In FIG. 5, U01 corresponds to the first node in the present application, and N02 corresponds to the second node in the present application. It should be particularly noted that the sequence illustrated herein does not set any limit on the orders in which signals are transmitted and implementations in this present application. Herein, steps in F51 are optional.

The first node U01 receives a first signaling and a second signaling in step S5101; transmits a first message in step S5102; and receives a fourth message in step S5103.

The second node N02 transmits a first signaling and a second signaling in step S5201; receives a first message in step S5202; and transmits a fourth message in step S5203.

In Embodiment 5, the first signaling is used for configuring at least one Radio Link Control (RLC) entity of a first cell group, while the second signaling configuring at least one RLC entity of a second cell group; and the first message requests a stop of transmission for a target cell group within a first time window set; the first time window set at least comprising one time window; the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the first node U01 is a UE.

In one embodiment, the first node U01 is a relay.

In one embodiment, the second node N02 is a UE.

In one embodiment, the second node N02 is a base station.

In one embodiment, the second node N02 is a satellite.

In one embodiment, the second node N02 is an NTN.

In one embodiment, the second node N02 is a TN.

In one embodiment, the second node N02 is a serving cell of the first node U01.

In one embodiment, the second node N02 is a Cell Group (CG) of the first node U01.

In one embodiment, the second node N02 is a primary serving cell (i.e., PCell) of the first node U01.

In one embodiment, the second node N02 is a secondary serving cell (i.e., SCell) of the first node U01.

In one embodiment, the second node N02 is an MCG of the first node U01.

In one embodiment, the second node N02 is an SCG of the first node U01.

In one embodiment, the second node N02 is a SpCell of the first node U01.

In one embodiment, an interface via which the second node N02 is in communication with the first node U01 includes Uu.

In one embodiment, an interface via which the second node N02 is in communication with the first node U01 includes PC5.

In one embodiment, the second node N02 is a Source Cell or a Target Cell of the first node U01.

In one embodiment, the second node N02 is a relay.

In one embodiment, a communication interface between the first node U01 and the second node N02 is a Uu interface.

In one embodiment, a communication interface between the first node U01 and the second node N02 is a PC5 interface.

In one embodiment, the first node U01 has two SIMs, including a first SIM and a second SIM.

In one embodiment, the two SIMs of the first node U01 correspond to two different PLMNs.

In one embodiment, the first SIM is a SIM for the second node N02; the second SIM is a SIM for a node or network other than the second node N02.

In one embodiment, the first SIM is a SIM of the second node N02 or the network of the second node N02; the second SIM is a SIM of a node other than the second node N02 or of a network other than the network of the second node N02.

In one embodiment, there exists an RRC linkage between the first node U01 and the second node N02.

In one embodiment, the first node U01 remains RRC Connected with the second node N02 within the first time window set.

In one embodiment, the second node N02 transmits the first configuration message by a PC5 interface.

In one embodiment, the second node N02 transmits the first configuration message by a Uu interface.

In one embodiment, the first cell group comprises the second node N02.

In one embodiment, the first cell group does not comprise the second node N02.

In one embodiment, the first cell group is an MCG of the first node U01.

In one embodiment, the first cell group is an SCG of the first node U01.

In one embodiment, the first cell group comprises part of cells in an MCG to which the second node N02 belongs.

In one embodiment, the first cell group comprises all of cells in an MCG to which the second node N02 belongs.

In one embodiment, the first cell group comprises part of cells in an SCG configured by the second node N02.

In one embodiment, the first cell group comprises all of cells in an SCG configured by the second node N02.

In one embodiment, the first cell group comprises all NTN cells.

In one embodiment, the first cell group comprises cell(s) within a specific area;

In one subembodiment, the specific area is determined by RAN-NotificationAreaInfo;

In one subembodiment, the specific area is determined by systemInformationAreaID;

In one subembodiment, the specific area is determined by a small data transmission area;

In one subembodiment, the specific area is determined by geographic coordinates.

In one embodiment, the first cell group does not comprise a target cell of the first node U01.

In one embodiment, the second cell group comprises the second node N02.

In one embodiment, the second cell group does not comprise the second node N02.

In one embodiment, the second cell group is an MCG of the first node U01.

In one embodiment, the second cell group is an SCG of the first node U01.

In one embodiment, the second cell group comprises part of cells in an MCG to which the second node N02 belongs.

In one embodiment, the second cell group comprises all of cells in an MCG to which the second node N02 belongs.

In one embodiment, the second cell group comprises part of cells in an SCG configured by the second node N02.

In one embodiment, the second cell group comprises all of cells in an SCG configured by the second node N02.

In one embodiment, the second cell group comprises all NTN cells.

In one embodiment, the second cell group comprises a cell within a specific area;

In one subembodiment, the specific area is determined by RAN-NotificationAreaInfo;

In one subembodiment, the specific area is determined by systemInformationAreaID;

In one subembodiment, the specific area is determined by a small data transmission area;

In one subembodiment, the specific area is determined by geographic coordinates.

In one embodiment, the second cell group does not comprise a target cell of the first node U01.

In one embodiment, the first signaling and the second signaling belong to different RRC messages, where the first signaling and the second signaling are respectively transmitted.

In one embodiment, the first signaling and the second signaling belong to a same RRC message, where the first signaling and the second signaling are simultaneously transmitted.

In one embodiment, the first signaling is transmitted by means of a broadcast or groupcast method, while the second signaling is transmitted by means of a unicast method.

In one embodiment, the second signaling is transmitted by means of a broadcast or groupcast method, while the first signaling is transmitted by means of a unicast method.

In one embodiment, the first signaling is an RRC signaling, while the second signaling is a MAC CE or a DCI.

In one embodiment, the second signaling is an RRC signaling, while the first signaling is a MAC CE or a DCI.

In one embodiment, the first signaling and the second signaling are transmitted before a start of the first time window set.

In one embodiment, the first signaling and the second signaling are received before a start of the first time window set.

In one embodiment, the first message is transmitted before a start of the first time window set.

In one embodiment, the first message indicates the first time window set.

In one embodiment, the first message indicates a candidate time window set, the candidate time window set used for determining the first time window set.

In one embodiment, the first message is transmitted by a Uu interface.

In one embodiment, the first message is transmitted by a PC5 interface.

In one embodiment, the fourth message comprises an RRC message.

In one embodiment, the fourth message comprises a NAS message.

In one embodiment, the fourth message comprises a PC5-RRC message.

In one embodiment, the fourth message comprises a PC5-S message.

In one embodiment, the fourth message comprises a SIB.

In one embodiment, the fourth message comprises a RRCReconfiguration.

In one embodiment, the fourth message comprises a RRCReconfigurationSidelink.

In one embodiment, the fourth message comprises a RRCConnectionReconfiguration.

In one embodiment, the fourth message comprises a RRCConnectionReconfigurationSidelink.

In one embodiment, the fourth message comprises a SpCellConfig.

In one embodiment, the fourth message is a RRCReconfiguration.

In one embodiment, the fourth message is a RRCReconfigurationSidelink.

In one embodiment, the fourth message is transmitted in a broadcast way.

In one embodiment, the fourth message is transmitted in a unicast way.

In one embodiment, the fourth message comprises a drx-config.

In one embodiment, the fourth message comprises a sl-drx-config.

In one embodiment, the fourth message comprises a drx-configsidelink.

In one embodiment, the fourth message comprises a cellgroupconfig.

In one embodiment, the fourth message comprises a MRDC-SecondaryCellGroupConfig.

In one embodiment, the fourth message comprises a MAC Control ELement (CE).

In one embodiment, the fourth message comprises Downlink Control Information (DCI).

In one embodiment, the fourth message is used for acknowledging a request of the first message.

In one embodiment, the fourth message is used for accepting a request of the first message.

In one embodiment, the fourth message indicates the first time window set.

In one embodiment, the fourth message indicates that the first node U01 stops transmission for a target cell group within a first time window set.

In one embodiment, the fourth message indicates an identity of the target cell group.

In one embodiment, the first message is used to determine that the fourth message is received via the at least one RLC entity of a reserved cell group, where the reserved cell group is a cell group other than the target cell group between the first cell group and the second cell group.

### Embodiment 6

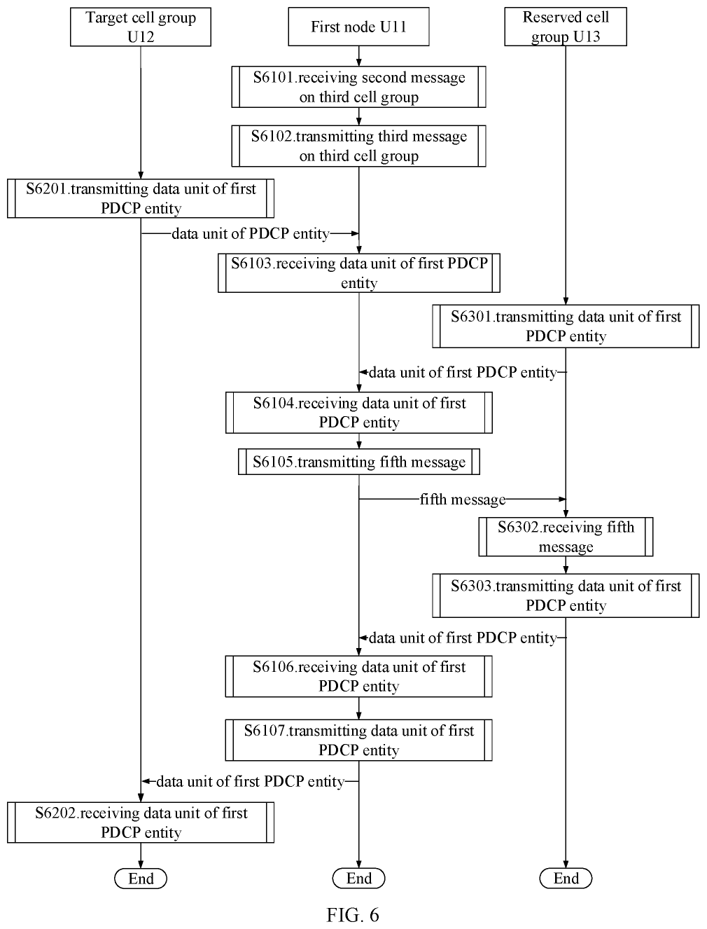

Embodiment 6 illustrates a flowchart of radio signal transmission according to one embodiment of the present application, as shown in FIG. 6. In FIG. 6, U11 corresponds to a first node in the present application, and U12 corresponds to a target cell group in the present application, and U13 corresponds to a reserved cell group in the present application; the reserved cell group is a cell group other than the target cell group between the first cell group and the second cell group. It should be particularly noted that the sequence illustrated herein does not set any limit to the signal transmission order or implementation order in the present application, where each step is optional.

The first node U11 receives a second message on a third cell group in step S6101; and transmits a third message on the third cell group in step S6102; receives a data unit of a first PDCP entity in step S6103; receives a data unit of a first PDCP entity in step S6104; and transmits a fifth message in step S6105; receives a data unit of a first PDCP entity in step S6106; and transmits a data unit of a first PDCP entity in step S6107.

The target cell group U12 transmits a data unit of a first PDCP entity in step S6201; and receives a data unit of the first PDCP entity in step S6202.

The reserved cell group U13 transmits a data unit of a first PDCP entity in step S6301; and receives a fifth message in step S6302; and transmits a data unit of the first PDCP entity in step S6303.

In Embodiment 6, the first node U11 receives a first signaling and a second signaling; the first signaling configuring at least one Radio Link Control (RLC) entity of a first cell group, while the second signaling configuring at least one RLC entity of a second cell group; and the first node U11 transmits a first message, the first message requesting a stop of transmission for a target cell group within a first time window set; the first time window set at least comprises one time window; herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the target cell group U12 is the first cell group; the reserved cell group U13 is the second cell group.

In one embodiment, the target cell group U12 is the second cell group; the reserved cell group U13 is the first cell group.

In one embodiment, the first node U11 receives a second message on a third cell group within the first time window set; or, transmits a third message on a third cell group within the first time window set; herein, frequency-domain resources occupied by the third cell group are used to determine the target cell group from the first cell group and the second cell group.

In one embodiment, how to determine the target cell group from the first cell group and the second cell group according to frequency-domain resources occupied by the third cell group is determined by the first node itself.

In one embodiment, how to determine the target cell group from the first cell group and the second cell group according to frequency-domain resources occupied by the third cell group is related to a radio frequency unit parameter of the first node.

In one embodiment, the target cell group is a cell group between the first cell group and the second cell group that has a smaller frequency-domain interval to the third cell group.

In one embodiment, the target cell group is a cell group between the first cell group and the second cell group by which a band occupied can compose a dual connectivity (DC) band combination together with a band occupied by the third cell group.

In one embodiment, the target cell group is a cell group between the first cell group and the second cell group that can share a same set of radio frequency units with the third cell group.

In one embodiment, the third cell group and the first cell group do not belong to a same network.

In one embodiment, the third cell group and the second cell group do not belong to a same network.

In one embodiment, the third cell group and the first cell group do not belong to a same PLMN.

In one embodiment, the third cell group and the second cell group do not belong to a same PLMN.

In one embodiment, the third cell group is not a target cell group of the first node U11.

In one embodiment, the third cell group does not comprise a target cell of the first node U11.

In one embodiment, the first node is in communication with the third cell group and the reserved cell group U13 simultaneously within the first time window set.

In one embodiment, the first node U11 at least receives a paging message through the third cell group.

In one embodiment, the first node U11 keeps an RRC connection with the third cell group or a network of the third cell group within the first time window set.

In one embodiment, the first node U11 receives a fourth message, the fourth message used for acknowledging a request of the first message.

In one embodiment, the first node U11 receives a data unit of a first PDCP entity via the at least one RLC entity of the target cell group U12 before the action of transmitting the first message; and receives a data unit of the first PDCP entity via the at least one RLC entity of a reserved cell group U13 in the first time window, where the reserved cell group U13 is a cell group other than the target cell group U12 between the first cell group and the second cell group;

herein, the first message is used for triggering a reception of a data unit of the first PDCP entity via the at least one RLC entity of the reserved cell group U13 in the first time window.

In one embodiment, the phrase that the first message is used for triggering a reception of a data unit of the first PDCP entity via the at least one RLC entity of the reserved cell group U13 in the first time window comprises: as a response to transmitting the first message, receiving a data unit of the first PDCP entity via the at least one RLC entity of the reserved cell group U13 in the first time window.

In one embodiment, the phrase that the first message is used for triggering a reception of a data unit of the first PDCP entity via the at least one RLC entity of the reserved cell group U13 in the first time window comprises: as a response to receiving the fourth message, receiving a data unit of the first PDCP entity via the at least one RLC entity of the reserved cell group U13 in the first time window.

In one embodiment, the first PDCP entity is associated with one SRB.

In one embodiment, the first PDCP entity is associated with one DRB.

In one embodiment, the data unit comprises a PDCP packet data unit/Protocol Data Unit (PDU).

In one embodiment, the data unit comprises a PDCP Service Data Unit (SDU).

In one embodiment, a serving cell of the first node U11 configures the first PDCP entity.

In one embodiment, a transmitter of the first signaling configures the first PDCP entity.

In one embodiment, the first signaling configures the first PDCP entity.

In one embodiment, the second signaling configures the first PDCP entity.

In one embodiment, the first PDCP entity is associated with the at least one RLC entity of the first cell group.

In one embodiment, the first PDCP entity is associated with the at least one RLC entity of the second cell group.

In one embodiment, the first node U11 maintains the first PDCP entity within the first time window set;

In one subembodiment, the first PDCP entity is not re-established within the first time window set;

In one subembodiment, the first PDCP entity is not released within the first time window set;

In one subembodiment, the first PDCP entity is not removed within the first time window set;

In one subembodiment, the first PDCP entity continues to be used within the first time window set;

In one subembodiment, a status variable of the first PDCP entity is retained within the first time window set;

In one subembodiment, the first node U11 transmits data via the first PDCP entity within the first time window set;

In one subembodiment, the first node U11 receives data via the first PDCP entity within the first time window set.

In one embodiment, the first PDCP entity is configured duplication.

In one embodiment, the first PDCP entity is associated with at least one RLC entity of the first cell group, and the first PDCP entity is associated with at least one RLC entity of the second cell group, where at least within the first time window a data unit of the first PDCP entity is transmitted or received only via an RLC entity of the reserved cell group; outside the first time window, a data unit of the first PDCP entity is only transmitted or received via an RLC entity of the first cell group, or, a data unit of the first PDCP entity is only transmitted or received via an RLC entity of the second cell group.

In one embodiment, the step S6201 occurs before a start of the first time window set.

In one embodiment, the step S6103 occurs before a start of the first time window set.

In one embodiment, the step S6301 occurs in the first time window set.

In one embodiment, the step S6104 occurs in the first time window set.

In one embodiment, the step S6303 occurs after an end of the first time window set.

In one embodiment, the step S6106 occurs after an end of the first time window set.

In one embodiment, the step S6202 occurs after an end of the first time window set.

In one embodiment, the step S6107 occurs after an end of the first time window set.

In one embodiment, as a response to determining a link failure of a reserved cell group U13, the first node U11 transmits a fifth message on the target cell group U12 within the first time window set;

herein, the fifth message indicates the link failure of the reserved cell group U13, where the reserved cell group U13 is a cell group other than the target cell group U12 between the first cell group and the second cell group.

In one embodiment, as a response to determining a link failure of a reserved cell group U13, the first node terminates transmission for the third cell group.

In one embodiment, as a response to determining a link failure of a reserved cell group U13, the first node terminates reception for the third cell group.

In one embodiment, as a response to determining a link failure of a reserved cell group U13, the first node releases an RLC entity used for communication with the third cell group.

In one embodiment, as a response to determining a link failure of a reserved cell group U13, the first node releases an SRB used for communication with the third cell group.

In one embodiment, as a response to determining a link failure of a reserved cell group U13, the first node releases a DRB used for communication with the third cell group.

In one embodiment, the fifth message comprises an Msg1.

In one embodiment, the fifth message comprises an Msg3.

In one embodiment, the fifth message comprises an MsgA.

In one embodiment, the fifth message comprises a RRCReestablishment.

In one embodiment, the reserved cell group U13 is an MCG, where the fifth message comprises a MCGFailureInformation message.

In one embodiment, the reserved cell group U13 is an SCG, where the fifth message comprises a SCGFailureInformation mess age.

In one embodiment, the fifth message comprises a RRCResumeRequest message.

In one embodiment, a random access instance indication from a MAC layer of the reserved cell group is used to determine the link failure of the reserved cell group U13.

In one embodiment, an indication of a consistent uplink LBT failure from a MAC layer of the reserved cell group is used to determine the link failure of the reserved cell group.

In one embodiment, an indication of reaching a maximum number of retransmissions from a MAC layer of the reserved cell group is used to determine the link failure of the reserved cell group U13.

In one embodiment, the link failure comprises a Radio Link Failure (RLF).

In one embodiment, the link failure comprises a beam Failure.

In one embodiment, when the first node U11 determines a link failure of the reserved cell group U13, the first node U11 transmits the fifth message.

In one embodiment, a transmission of the fifth message is triggered by that the first node U11 determines a link failure of the reserved cell group U13.

In one embodiment, as a response to determining a link failure of a reserved cell group U13, the first node U11 releases the reserved cell group U13 in the first time window set.

In one embodiment, the first node U11 transmits a data unit of a first PDCP entity via the at least one RLC entity of the target cell group U12 after an end of the first time window;

In one subembodiment, a data unit of the first PDCP entity occupies time-frequency resources of the target cell group;

In one subembodiment, a data unit of the first PDCP entity scrambles in a Physical Layer using scrambling of the target cell group;

In one subembodiment, a data unit of the first PDCP entity scrambles in a Physical Layer using scrambling of an SSB of the target cell group;

In one subembodiment, a data unit of the first PDCP entity is transmitted using the at least one RLC entity of the target cell group.

In one embodiment, the first node U11 receives a data unit of a first PDCP entity via the at least one RLC entity of the target cell group U12 after an end of the first time window;

In one subembodiment, a data unit of the first PDCP entity occupies time-frequency resources of the target cell group;

In one subembodiment, a data unit of the first PDCP entity scrambles in a Physical Layer using scrambling of the target cell group;

In one subembodiment, a data unit of the first PDCP entity scrambles in a Physical Layer using scrambling of an SSB of the target cell group;

In one subembodiment, a data unit of the first PDCP entity is received using the at least one RLC entity of the target cell group.

In one embodiment, after an end of the first time window set, the first node U11 itself resumes communication with the target cell group U12.

In one embodiment, after an end of the first time window set, the first node U11 itself resumes the latest configuration for the target cell group U12 before a start of the first time window set.

In one embodiment, after an end of the first time window, the first node U11 re-establishes the at least one RLC entity of the target cell group U12.

In one embodiment, after an end of the first time window set, the first node U11 activates the target cell group U12.

In one embodiment, at a start of the first time window set, the first node U11 deactivates the target cell group U12.

In one embodiment, a transmission of the first message is used for deactivating the target cell group U12.

In one embodiment, a reception of the fourth message is used for deactivating the target cell group U12.

### Embodiment 7

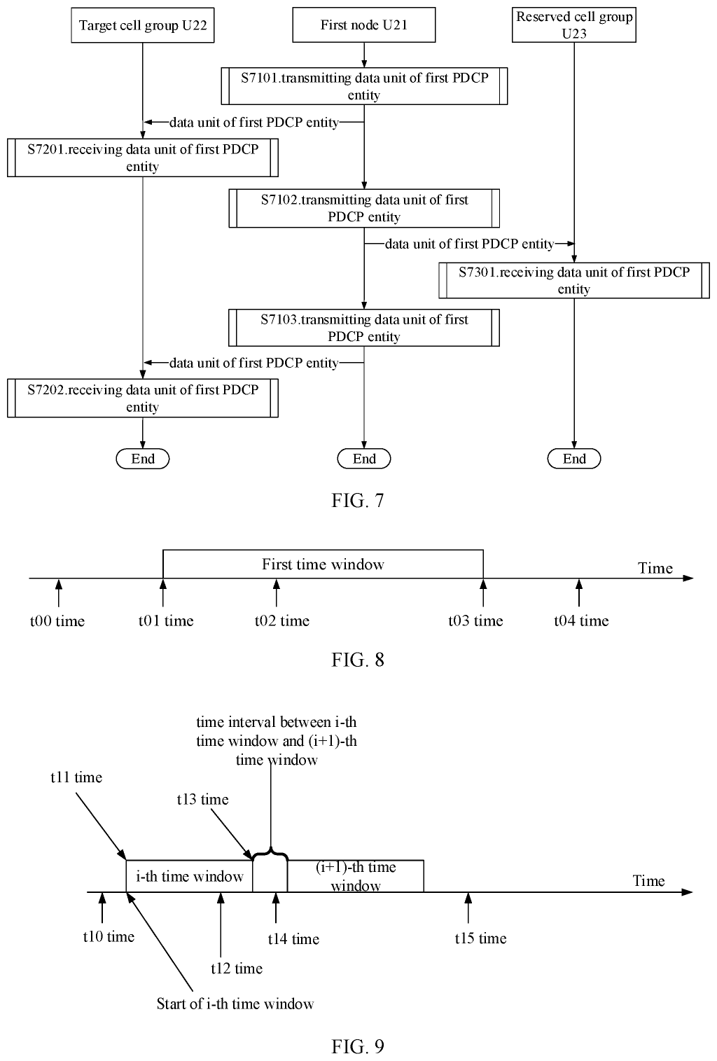

Embodiment 7 illustrates a flowchart of radio signal transmission according to one embodiment of the present application, as shown in FIG. 7. In FIG. 7, U21 corresponds to a first node in the present application, and U22 corresponds to a target cell group in the present application, and U23 corresponds to a reserved cell group in the present application; the reserved cell group is a cell group other than the target cell group between the first cell group and the second cell group. It should be particularly noted that the sequence illustrated herein does not set any limit to the signal transmission order or implementation order in the present application, where each step is optional. With Embodiment 6 as the foundation, anything necessary but not explained in Embodiment 7 can be found in Embodiment 6.

The first node U21 transmits a data unit of a first PDCP entity in step S7101; and transmits a data unit of the first PDCP entity in step S7102; and transmits a data unit of the first PDCP entity in step S7103.

The target cell group U22 receives a data unit of a first PDCP entity in step S7201; and receives a data unit of the first PDCP entity in step S7202.

The reserved cell group U23 receives a data unit of a first PDCP entity in step S7301.

In Embodiment 7, the first node U21 receives a first signaling and a second signaling; the first signaling configuring at least one Radio Link Control (RLC) entity of a first cell group, while the second signaling configuring at least one RLC entity of a second cell group; and the first node U21 transmits a first message, the first message requesting a stop of transmission for a target cell group within a first time window set; the first time window set at least comprises one time window; herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the first node U21 transmits a data unit of a first PDCP entity via the at least one RLC entity of the target cell group U12 before the action of transmitting the first message; and transmits a data unit of the first PDCP entity via the at least one RLC entity of a reserved cell group U23 in the first time window, where the reserved cell group U23 is a cell group other than the target cell group U22 between the first cell group and the second cell group;

herein, the first message is used for triggering a transmission of a data unit of the first PDCP entity via the at least one RLC entity of the reserved cell group U23 in the first time window.

In one embodiment, when and only when the first node U21 transmits the first message will the first node U21 transmit a data unit of the first PDCP entity via the at least one RLC entity of the reserved cell U23 in the first time window.

In one embodiment, the phrase that the first message is used for triggering a transmission of a data unit of the first PDCP entity via the at least one RLC entity of the reserved cell group in the first time window comprises: as a response to transmitting the first message, transmitting a data unit of the first PDCP entity via the at least one RLC entity of the reserved cell group in the first time window.

In one embodiment, the phrase that the first message is used for triggering a transmission of a data unit of the first PDCP entity via the at least one RLC entity of the reserved cell group in the first time window comprises: as a response to receiving the fourth message, transmitting a data unit of the first PDCP entity via the at least one RLC entity of the reserved cell group in the first time window.

In one embodiment, the first PDCP entity is associated with one SRB.

In one embodiment, the first PDCP entity is associated with one DRB.

In one embodiment, the data unit comprises a PDCP PDU.

In one embodiment, the data unit comprises a PDCP SDU.

In one embodiment, the step S7101 occurs before a start of the first time window set.

In one embodiment, the step S7201 occurs before a start of the first time window set.

In one embodiment, the step S7102 occurs in the first time window set.

In one embodiment, the step S7301 occurs in the first time window set.

In one embodiment, the step S7103 occurs after an end of the first time window set.

In one embodiment, the step S7202 occurs after an end of the first time window set.

In one embodiment, the first node U21 transmits a data unit of a first PDCP entity via the at least one RLC entity of the target cell group U22 after an end of the first time window.

In one embodiment, the first node U21 receives a data unit of a first PDCP entity via the at least one RLC entity of the target cell group U22 after an end of the first time window.

In one embodiment, after an end of the first time window set, the first node U21 itself resumes communication with the target cell group U22.

In one embodiment, after an end of the first time window set, the first node U21 itself resumes the latest configuration for the target cell group U22 before a start of the first time window set.

In one embodiment, after an end of the first time window, the first node U21 re-establishes the at least one RLC entity of the target cell group U22.

In one embodiment, after an end of the first time window set, the first node U21 activates the target cell group U22.

In one embodiment, at a start of the first time window set, the first node U21 deactivates the target cell group U22.

In one embodiment, a transmission of the first message is used for deactivating the target cell group U22.

In one embodiment, a reception of the fourth message is used for deactivating the target cell group U22.

### Embodiment 8

Embodiment 8 illustrates a schematic diagram of a first time window set according to one embodiment of the present application, as shown in FIG. 8.

In Embodiment 8, the first time window set only comprises one time window, i.e., a first time window; a t00 time is a time before a start of the first time window; a t01 time is a start of the first time window; a t02 time is a time within the first time window; a t03 time is an end of the first time window; a t04 time is a time after an end of the first time window. It should be noted that geometric distances mutually between the t00 time, the t01 time, the t02 time, the t03 time, and the t04 time shown in FIG. 8 do not imply exact time intervals among them; for instance, in FIG. 8, that the distance between the t03 time and the t04 time is smaller than the distance between the t02 time and the t03 time does not necessary mean that a time interval between the t02 time and the t03 time is larger than a time interval between the t03 time and the t04 time.

In one embodiment, a transmission time of the first message is the t00 time.

In one embodiment, a transmission time of the first message is the t01 time.

In one embodiment, a reception time of the first signaling is the t00 time.

In one embodiment, a reception time of the first signaling is a time before the t00 time.

In one embodiment, a reception time of the second signaling is the t00 time.

In one embodiment, a reception time of the second signaling is a time before the t00 time.

In one embodiment, the first time window comprises T time units, where the time unit includes at least one of {millisecond, second, an OFDM symbol, a slot, a mini-slot, a sub-frame, a frame, a hyper-frame, minute, a periodicity of Discontinuous Reception (DRX), a paging periodicity, a periodicity of modification, a system message periodicity};

In one subembodiment, T is a positive integer;

In one subembodiment, T is finite.

In one embodiment, time-domain resources occupied by the first time window are limited.

In one embodiment, a length of the first time window is limited.

In one embodiment, the first message indicates at least one of the {t00 time, t01 time, t02 time, t03 time, t04 time}.

In one embodiment, at least one of the at least one RLC entity of the first cell group or the at least one RLC entity of the second cell group is maintained in the first time window set.

In one embodiment, both of the at least one RLC entity of the first cell group and the at least one RLC entity of the second cell group are maintained in the first time window set.

In one embodiment, at least one of the at least one RLC entity of the first cell group or the at least one RLC entity of the second cell group is maintained since the t00 time.

In one embodiment, at least one of the at least one RLC entity of the first cell group or the at least one RLC entity of the second cell group is maintained till the t03 time or the t04 time.

In one embodiment, a time interval between the time t00 and the time t01 is related to a frequency transition time of a transmitter of the first node;

In one subembodiment, a time interval between the time t00 and the time t01 is related to N_{TX1-TX2}.

In one embodiment, the fourth message indicates at least one of the {t00 time, t01 time, t02 time, t03 time, t04 time}.

In one embodiment, the first node is in communication with the third cell group from the time t01 to the time t04.

In one embodiment, the first time window does not comprise an active time.

In one embodiment, the first time window comprises an active time.

In one embodiment, the first message explicitly indicates a start and an end of the first time window.

In one embodiment, the fourth message explicitly indicates a start and an end of the first time window.

### Embodiment 9

Embodiment 9 illustrates a schematic diagram of a first time window set according to one embodiment of the present application, as shown in FIG. 9.

In Embodiment 9, the first time window set comprises K1 time windows, K1 being a positive integer greater than 1; FIG. 9 illustrates an i-th time window and a (i+1)-th time window among them, where i is a positive integer no greater than K1-1; In FIG. 9, a t10 time is a time before the i-th time window; a t11 time is a start of an i-th time window; a t12 time is a time within the i-th time window; a t13 time is an end of the i-th time window; a t14 time is a time between the i-th time window and the (i+1)-th time window; a t15 time is an end of the (i+1)-th time window; It should be noted that geometric distances mutually between the t10 time, the t11 time, the t12 time, the t13 time, the t14 time and the t15 time shown in FIG. 9 do not imply exact time intervals among them; for instance, in FIG. 9, that the distance between the t11 time and the t12 time is larger than the distance between the t12 time and the t13 time does not necessary mean that a time interval between the t11 time and the t12 time is larger than a time interval between the t12 time and the t13 time.

In one embodiment, K1 is infinity.

In one embodiment, K1 is finite.

In one embodiment, K1 is equal to 2.

In one embodiment, intervals mutually between the K1 time windows are of equal lengths.

In one embodiment, intervals mutually between the K1 time windows are of unequal lengths.

In one embodiment, intervals mutually between the K1 time windows are no smaller than a slot.

In one embodiment, lengths of all time windows among the K1 time windows are of equal lengths.

In one embodiment, there are at least 2 time windows of unequal lengths among the K1 time windows.

In one embodiment, each of intervals mutually between the K1 time windows is larger than a length of a shortest time window among the K1 time windows.

In one embodiment, a length of each of the K1 time windows is measured in time.

In one embodiment, a length of each time window among the K1 time windows is no smaller than a slot.

In one embodiment, i is equal to 1.

In one embodiment, the i+1 is equal to K1, where K1 is finite.

In one embodiment, there exists/exist other time window(s) before the i-th time window;

In one subembodiment, the t10 time does not belong to the first time window set;

In one subembodiment, the t10 time belongs to the first time window set.

In one embodiment, there does not exist any other time window before the i-th time window, where the time t10 does not belong to the first time window set.

In one embodiment, there exists/exist other time window(s) after the (i+1)-th time window;

In one subembodiment, the t15 time does not belong to the first time window set;

In one subembodiment, the t15 time belongs to the first time window set.

In one embodiment, there exists no other time window after the (i+1)-th time window;

In one subembodiment, the t15 time does not belong to the first time window set.

In one embodiment, the K1 time windows occur periodically in time domain.

In one embodiment, the K1 time windows occur periodically in time domain, where the periodicity depends on a paging period of the first node.

In one embodiment, the K1 time windows occur periodically in time domain, where the periodicity depends on a transmission delay of the first node.

In one embodiment, time-domain resources occupied by any time window among the K1 time windows are limited.

In one embodiment, a length of any time window among the K1 time windows is limited.

In one embodiment, the first message implicitly indicates the first time window set, where the periodicity of the first time window set is a paging period of the first node.

In one embodiment, the first message indicates a start of the first time window set.

In one embodiment, the first message indicates a periodicity of time windows in the first time window set in time domain.

In one embodiment, the first message indicates an end of the first time window set.

In one embodiment, the first message indicates a number of time windows in the first time window set.

In one embodiment, the first message indicates an offset of the first time window set in time domain;

In one subembodiment, the first message indicates a time offset of the first time window set relative to a paging period of the first node in time domain;

In one subembodiment, the first message indicates a time offset of the first time window set relative to a system message in time domain;

In one subembodiment, the first message indicates a time offset of the first time window set relative to on duration of DRX of the first node in time domain;

In one subembodiment, the first message indicates a time offset of the first time window set relative to a start of the second timer in time domain.

In one embodiment, a transmission time of the first message is one of the {t10 time, t11 time, t12 time, t13 time, t14 time}.

In one embodiment, a transmission time of the first message is the t10 time.

In one embodiment, a reception time of the first signaling is the t10 time.

In one embodiment, a reception time of the first signaling is a time before the t10 time.

In one embodiment, the first time window set has started when the first signaling is received; the first configuration message is used for updating the first time window set.

In one embodiment, the first time window set has not yet started when the first signaling is received.

In one embodiment, a reception time of the second signaling is the t10 time.

In one embodiment, a reception time of the second signaling is a time before the t10 time.

In one embodiment, the first time window set has started when the second signaling is received; the first configuration message is used for updating the first time window set.

In one embodiment, the first time window set has not yet started when the second signaling is received.

In one embodiment, the i-th time window among the K1 time windows comprises Ti time units, where the time unit includes at least one of {millisecond, second, an OFDM symbol, a slot, a mini-slot, a sub-frame, a frame, a hyper-frame, minute, a periodicity of Discontinuous Reception (DRX), a paging periodicity, a periodicity of modification, a system message periodicity}.

In one embodiment, the first node receives the first signaling, the first signaling being an RRC signaling, and the first signaling indicating the first time window set;

In one subembodiment, a reception of the first signaling is later than a transmission of the first message;

In one subembodiment, the first message is used for triggering the first signaling;

In one subembodiment, the first signaling comprises a RRCReconfiguration;

In one subembodiment, the first signaling comprises a DCI;

In one subembodiment, the first signaling comprises a MAC CE;

In one subembodiment, the first signaling is used for accepting a request of the first message;

In one subembodiment, the first node transmits a second signaling, the second signaling being used for feedback of the first signaling;

In one subembodiment, the second signaling comprises a RRCReconfigurationComplete.

In one embodiment, the first message indicates at least one of {t10 time, t11 time, t12 time, t13 time, t14 time, t15 time}.

In one embodiment, the fourth message indicates at least one of {t10 time, t11 time, t12 time, t13 time, t14 time, t15 time}.

In one embodiment, at least one of the at least one RLC entity of the first cell group or the at least one RLC entity of the second cell group is maintained in the first time window set.

In one embodiment, both of the at least one RLC entity of the first cell group and the at least one RLC entity of the second cell group are maintained in the first time window set.

In one embodiment, at least one of the at least one RLC entity of the first cell group or the at least one RLC entity of the second cell group is maintained since the t10 time.

In one embodiment, at least one of the at least one RLC entity of the first cell group or the at least one RLC entity of the second cell group is maintained till the t13 time or the t14 time.

In one embodiment, a time interval between the time t10 and the time t11 is related to a frequency transition time of a transmitter of the first node;

In one subembodiment, a time interval between the time t10 and the time t11 is related to N_{TX1-TX2}.

In one embodiment, the first node is in communication with the third cell group from the time t11 to the time t13.

In one embodiment, the first time window set does not comprise an active time.

In one embodiment, the first time window set comprises an active time.

In one embodiment, the first message explicitly indicates a start and an end of the first time window set.

In one embodiment, the fourth message explicitly indicates a start and an end of the first time window set.

### Embodiment 10

Embodiment 10 illustrates a schematic diagram of the network according to one embodiment of the present application, as shown in FIG. 10.

In one embodiment, the first node in FIG. 10 corresponds to the first node in the present application.

In one embodiment, the second node in the present application is network A.

In one embodiment, the second node in the present application belongs to the network A.

In one embodiment, the first node has two SIMs, which respectively correspond to the network A and network B.

In one embodiment, the network A is different from the network B in PLMN.

In one embodiment, the network A is an NR network, while the network B is an E-UTRA network.

In one embodiment, the network A is an NR network, while the network B is an NR network.

In one embodiment, the first node keeps an RRC connection with the network A.

In one embodiment, the first node keeps an RRC connection with the network B.

In one embodiment, an RRC state between the first node and the network B includes an idle state and an inactive state.

In one embodiment, the first node at least has two MAC entities, respectively corresponding to the network A and the network B.

In one embodiment, the first node at least has three MAC entities, among which two correspond to the network A and the other one corresponds to the network B.

In one embodiment, the transmitter of the first signaling and the second signaling is a serving cell of the network A.

In one embodiment, the first message is transmitted for a serving cell of the network A.

In one embodiment, the MAC entity corresponding to the network A is in an Active Time.

In one embodiment, cells in the target cell group are in an Active Time.

In one embodiment, cells in the reserved cell group are in an Active Time.

In one embodiment, within the first time window set, if the first cell group is determined to be the target cell group, a reserved cell group is the second cell group, or if the second cell group is determined to be the target cell group, a reserved cell group is the first cell group.

In one embodiment, the first cell group and the second cell group have an identical PLMN.

In one embodiment, the first cell group is different from the third cell group in PLMN.

In one embodiment, the second cell group is different from the third cell group in PLMN.

In one embodiment, the first cell group belongs to the network A.

In one embodiment, the second cell group belongs to the network A.

In one embodiment, the third cell group belongs to the network B.

In one embodiment, the first node is in communication with the network B within the first time window set.

In one embodiment, the first node is only in communication with the network B within the first time window set.

In one embodiment, within the first time window set, the first node receives a System Information Block (SIB) of the target cell group.

In one embodiment, within the first time window set, the first node receives a SIB of the reserved cell group.

In one embodiment, within the first time window set, the first node receives a SIB of the third cell group.

### Embodiment 11

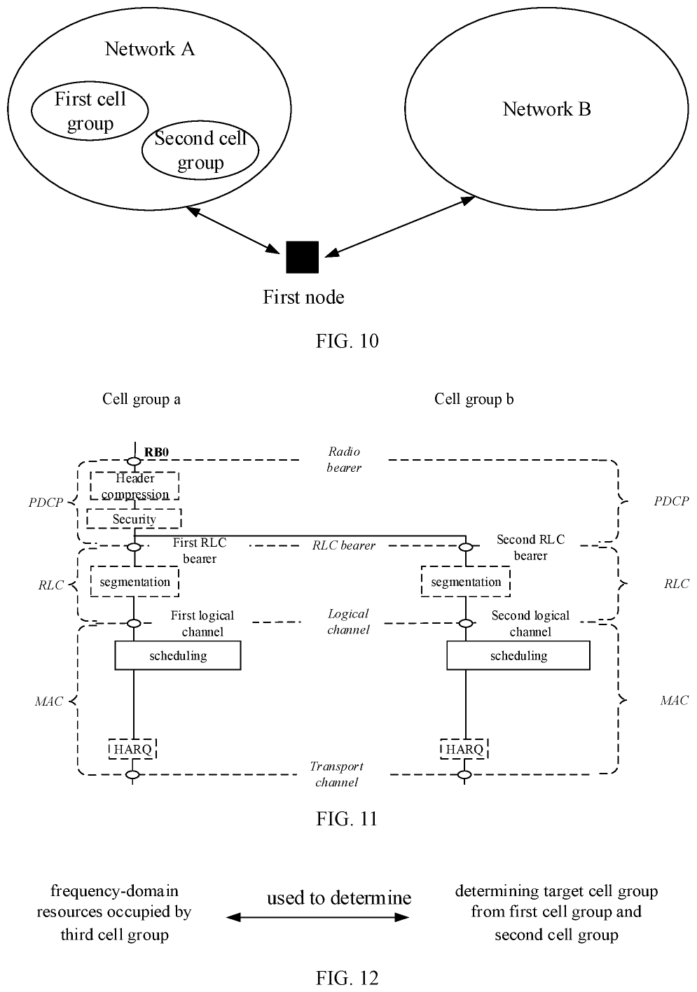

Embodiment 11 illustrates a schematic diagram of an RLC entity according to one embodiment of the present application, as shown in FIG. 11; where functions in the dotted-line boxes are optional.

In one embodiment, a cell group a in FIG. 11 corresponds to the first cell group in the present application; a cell group b in FIG. 11 corresponds to the second cell group in the present application.

In one embodiment, a cell group b in FIG. 11 corresponds to the first cell group in the present application; a cell group a in FIG. 11 corresponds to the second cell group in the present application.

In one embodiment, the cell group a is an MCG of the first node, while the cell group b is an SCG of the first node.

In one embodiment, the cell group a is an SCG of the first node, while the cell group b is an MCG of the first node.

In one embodiment, the cell group a is an SCG of the first node, while the cell group b is an SCG of the first node.

In one embodiment, RB0 in FIG. 11 is an SRB.

In one embodiment, RB0 in FIG. 11 is a DRB.

In one embodiment, RB0 in FIG. 11 is a Multicast Broadcast Service (MBS) RB.

In one embodiment, a PDCP entity corresponding to the RB0 is the first PDCP entity.

In one embodiment, the cell group a at least comprises one RLC entity;

In one subembodiment, the cell group a comprises a first RLC entity;

In one subembodiment, the first RLC entity corresponds to a first RLC bearer;

In one subembodiment, the first RLC bearer corresponds to a first logical channel.

In one embodiment, the cell group b at least comprises one RLC entity;

In one subembodiment, the cell group b comprises a second RLC entity;

In one subembodiment, the second RLC entity corresponds to a second RLC bearer;

In one subembodiment, the second RLC bearer corresponds to a second logical channel.

In one embodiment, the first RLC entity is associated with the first PDCP entity.

In one embodiment, the first RLC entity processes a data unit of the first PDCP entity.

In one embodiment, the first RLC entity receives a data unit of the first PDCP entity.

In one embodiment, the first RLC entity transmits a data unit of the first PDCP entity.

In one embodiment, the second RLC entity is associated with the first PDCP entity.

In one embodiment, the second RLC entity processes a data unit of the first PDCP entity.

In one embodiment, the second RLC entity receives a data unit of the first PDCP entity.

In one embodiment, the second RLC entity transmits a data unit of the first PDCP entity.

In one embodiment, the first RLC entity and the second RLC entity simultaneously receive or transmit a data unit of the first PDCP entity.

In one embodiment, the first RLC entity and the second RLC entity neither simultaneously receive nor simultaneously transmit a data unit of the first PDCP entity.

In one embodiment, the first RLC entity and the second RLC entity do not simultaneously transmit but simultaneously receive a data unit of the first PDCP entity.

In one embodiment, FIG. 11 is a protocol stack for the baseband side.

In one embodiment, FIG. 11 is a protocol stack for the first node.

In one embodiment, the target cell group is the cell group a; the reserved cell group is the cell group b.

In one embodiment, within the first time window set, the first node receives a data unit of the first PDCP entity via the second RLC entity.

In one embodiment, within the first time window set, the first node transmits a data unit of the first PDCP entity via the second RLC entity.

In one embodiment, before a start of the first time window set, the first node at least receives a data unit of the first PDCP entity via the first RLC entity.

In one embodiment, before a start of the first time window set, the first node at least transmits a data unit of the first PDCP entity via the first RLC entity.

In one embodiment, before a start of the first time window set, the first node only receives a data unit of the first PDCP entity via the first RLC entity.

In one embodiment, before a start of the first time window set, the first node only transmits a data unit of the first PDCP entity via the first RLC entity.

In one embodiment, after an end of the first time window set, the first node at least receives a data unit of the first PDCP entity via the first RLC entity.

In one embodiment, after an end of the first time window set, the first node at least transmits a data unit of the first PDCP entity via the first RLC entity.

In one embodiment, after an end of the first time window set, the first node only receives a data unit of the first PDCP entity via the first RLC entity.

In one embodiment, after an end of the first time window set, the first node only transmits a data unit of the first PDCP entity via the first RLC entity.

In one embodiment, the first node maintains the first RLC entity within the first time window set.

In one embodiment, the first node maintains the second RLC entity within the first time window set.

### Embodiment 12

Embodiment 12 illustrates a schematic diagram of frequency-domain resources occupied by a third cell group being used to determine a target cell group from a first cell group and a second cell group according to one embodiment of the present application, as shown in FIG. 12.

In one embodiment, the first node receives a second message on a third cell group within the first time window set; or, the first node transmits a third message on a third cell group within the first time window set;
herein, frequency-domain resources occupied by the third cell group are used to determine the target cell group from the first cell group and the second cell group.

In one embodiment, the first node receives a fourth message; the fourth message is used for acknowledging a request of the first message.

In one embodiment, how to determine the target cell group from the first cell group and the second cell group according to frequency-domain resources occupied by the third cell group is determined by the first node itself.

In one embodiment, how to determine the target cell group from the first cell group and the second cell group according to frequency-domain resources occupied by the third cell group is related to a radio frequency unit parameter of the first node.

In one embodiment, the target cell group is a cell group between the first cell group and the second cell group that has a smaller frequency-domain interval to the third cell group.

In one embodiment, the target cell group is a cell group between the first cell group and the second cell group by which a band occupied can compose a dual connectivity (DC) band combination together with a band occupied by the third cell group.

In one embodiment, the target cell group is a cell group between the first cell group and the second cell group that can share a same set of radio frequency units with the third cell group.

In one embodiment, the target cell group is an SCG of the first node.

In one embodiment, the third cell group belongs to a different network from the first cell group and the second cell group.

In one embodiment, the third cell group belongs to a different Public Land Mobile Network (PLMN) from the first cell group and the second cell group.

In one embodiment, the third cell group corresponds to a different SIM from the first cell group and the second cell group.

In one embodiment, the target cell group and the third cell group do not belong to the same frequency combination.

In one embodiment, the target cell group and the third cell group do not belong to the same multi-connectivity frequency combination.

In one embodiment, the target cell group and the third cell group do not belong to a same BandCombination-MRD C.

In one embodiment, the target cell group and the third cell group do not belong to a same BandCombination-UplinkTxSwitch.

In one embodiment, the reserved cell group and the third cell group belong to the same frequency combination.

In one embodiment, the reserved cell group and the third cell group belong to the same multi-connectivity frequency combination.

In one embodiment, the reserved cell group and the third cell group belong to a same BandCombination-MRD C.

In one embodiment, the reserved cell group and the third cell group belong to a same BandCombination-UplinkTxSwitch.

In one embodiment, the first message indicates a first frequency, the first frequency being a carrier frequency of the third cell group.

In one embodiment, the first message indicates a first frequency combination, the first frequency combination comprising at least one frequency;

In one subembodiment, the first frequency combination is a frequency combination of the third cell group;

In one subembodiment, the first frequency combination is a frequency combination of the third cell group and a fourth cell group; the third cell group and the fourth cell group belong to a same network; In one subembodiment, the first frequency combination indicates a BandCombination-MRDC of the third cell group;

In one subembodiment, the first frequency combination indicates a BandCombination-UplinkTxSwitch of the third cell group;

In one subembodiment, the first frequency combination indicates a carrier frequency of the third cell group;

In one subembodiment, the first frequency combination is used to determine the target cell group;

In one subembodiment, the fourth message indicates the target cell group;

In one subembodiment, a carrier frequency of the first cell group is used to determine the target cell group;

In one subembodiment, a carrier frequency of the second cell group is used to determine the target cell group.

In one embodiment, the first node is capable of being simultaneously connected with the reserved cell group and the third cell group.

In one embodiment, the first node is capable of being simultaneously in communication with the reserved cell group and the third cell group.

In one embodiment, the first node is capable of receiving signals from the reserved cell group and the third cell group simultaneously.

In one embodiment, the first node is capable of transmitting signals to the reserved cell group and the third cell group simultaneously.

In one embodiment, the first node is incapable of being simultaneously connected with the target cell group and the third cell group.

In one embodiment, the first node is incapable of being simultaneously in communication with the target cell group and the third cell group.

In one embodiment, the first node is incapable of receiving signals from the target cell group and the third cell group simultaneously.

In one embodiment, the first node is incapable of transmitting signals to the target cell group and the third cell group simultaneously.

In one embodiment, the reserved cell group and the third cell group have identical radio frequency parameters.

In one embodiment, the target cell group and the third cell group do not have identical radio frequency parameters.

### Embodiment 13

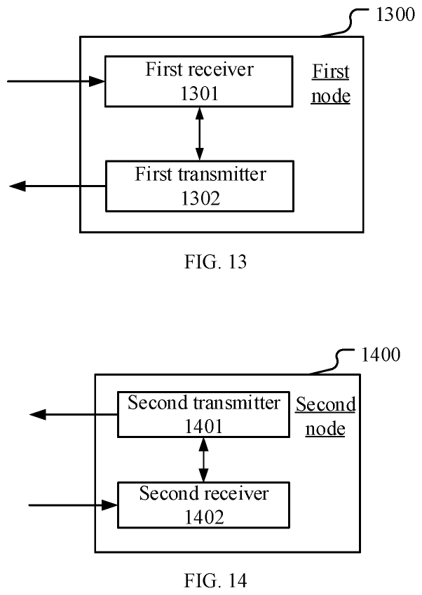

Embodiment 13 illustrates a structure block diagram of a processing device used in a first node according to one embodiment of the present application; as shown in FIG. 13. In FIG. 13, a processing device 1300 in a first node comprises a first receiver 1301 and a first transmitter 1302. In Embodiment 13,
the first receiver 1301 receives a first signaling and a second signaling; the first signaling configuring at least one Radio Link Control (RLC) entity of a first cell group, while the second signaling configuring at least one RLC entity of a second cell group; and
the first transmitter 1302 transmits a first message, the first message requesting a stop of transmission for a target cell group within a first time window set; the first time window set at least comprising one time window;
herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, the first receiver 1301 receives a second message on a third cell group within the first time window set; or, the first transmitter 1302 transmits a third message on a third cell group within the first time window set;
herein, frequency-domain resources occupied by the third cell group are used to determine the target cell group from the first cell group and the second cell group.

In one embodiment, the first receiver 1301 receives a fourth message;
herein, the fourth message is used for acknowledging a request of the first message.

In one embodiment, the first transmitter 1302, as a response to determining a link failure of a reserved cell group, transmits a fifth message on the target cell group within the first time window set;
herein, the fifth message indicates the link failure of the reserved cell group, where the reserved cell group is a cell group other than the target cell group between the first cell group and the second cell group.

In one embodiment, the first receiver 1301 receives a data unit of a first PDCP entity via the at least one RLC entity of the target cell group before the action of transmitting the first message; and a data unit of the first PDCP entity is received via the at least one RLC entity of a reserved cell group in the first time window set, where the reserved cell group is a cell group other than the target cell group between the first cell group and the second cell group;
herein, the first message is used for triggering a reception of a data unit of the first PDCP entity via the at least one RLC entity of the reserved cell group in the first time window set.

In one embodiment, the first receiver 1301 receives a data unit of the first PDCP entity via the at least one RLC entity of the reserved cell group after an end of the first time window set.

In one embodiment, the first transmitter 1302 transmits a data unit of the first PDCP entity via the at least one RLC entity of the target cell group after an end of the first time window set.

In one embodiment, the first transmitter 1302 transmits a data unit of a first PDCP entity via the at least one RLC entity of the target cell group before the action of transmitting the first message; and transmits a data unit of the first PDCP entity via the at least one RLC entity of a reserved cell group in the first time window, where the reserved cell group is a cell group other than the target cell group between the first cell group and the second cell group;
herein, the first message is used for triggering a transmission of a data unit of the first PDCP entity via the at least one RLC entity of the reserved cell group in the first time window.

In one embodiment, the first node 1300 maintains a MAC entity of the first cell group and a MAC entity of the second cell group within the first time window set.

In one embodiment, the first node is a UE.

In one embodiment, the first node is a terminal supporting large delay difference.

In one embodiment, the first node is a terminal supporting NTN.

In one embodiment, the first node is an aircraft.

In one embodiment, the first node is a vehicle-mounted terminal.

In one embodiment, the first node is a relay.

In one embodiment, the first node is a vessel.

In one embodiment, the first node is an IoT terminal.

In one embodiment, the first node is an IIoT terminal.

In one embodiment, the first node is a piece of equipment supporting transmissions with low delay and high reliability.

In one embodiment, the first node is a multicast-supporting node.

In one embodiment, the first receiver 1301 comprises at least one of the antenna 452, the receiver 454, the receiving processor 456, the multi-antenna receiving processor 458, the controller/processor 459, the memory 460 or the data source 467 in Embodiment 4.

In one embodiment, the first transmitter 1302 comprises at least one of the antenna 452, the transmitter 454, the transmitting processor 468, the multi-antenna transmitting processor 457, the controller/processor 459, the memory 460 or the data source 467 in Embodiment 4.

### Embodiment 14

Embodiment 14 illustrates a structure block diagram of a processing device used in a second node according to one embodiment of the present application; as shown in FIG. 14. In FIG. 14, a processing device 1400 in a second node comprises a second transmitter 1401 and a second receiver 1402. In Embodiment 14,
the second transmitter 1401 transmits a first signaling and a second signaling; the first signaling configuring at least one Radio Link Control (RLC) entity of a first cell group, while the second signaling configuring at least one RLC entity of a second cell group; and
the second receiver 1402 receives a first message, the first message requesting a stop of transmission for a target cell group within a first time window set; the first time window set at least comprising one time window;
herein, the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

In one embodiment, a transmitter of the first message receives a second message on a third cell group within the first time window set; or, transmits a third message on a third cell group within the first time window set;

herein, frequency-domain resources occupied by the third cell group are used to determine the target
cell group from the first cell group and the second cell group.

In one embodiment, the second transmitter 1401 transmits a fourth message;
herein, the fourth message is used for acknowledging a request of the first message.

In one embodiment, the second transmitter 1401 receives a fifth message on the target cell group within the first time window set;
herein, the fifth message indicates the link failure of the reserved cell group, where the reserved cell group is a cell group other than the target cell group between the first cell group and the second cell group.

In one embodiment, the second transmitter 1401 transmits a data unit of a first PDCP entity via the at least one RLC entity of the target cell group, where the action of transmitting a data unit of the first PDCP entity via the at least one RLC entity of the target cell group is performed before the action of receiving the first message; a data unit of the first PDCP entity is transmitted via the at least one RLC entity of a reserved cell group in the first time window set, where the reserved cell group is a cell group other than the target cell group between the first cell group and the second cell group;

herein, the first message is used for triggering a transmission of a data unit of the first PDCP entity via
the at least one RLC entity of the reserved cell group in the first time window set.

In one embodiment, the second receiver 1402 receives a data unit of a first PDCP entity via the at least one RLC entity of the target cell group before the action of transmitting the first message; and receives a data unit of the first PDCP entity via the at least one RLC entity of a reserved cell group in the first time window, where the reserved cell group is a cell group other than the target cell group between the first cell group and the second cell group;
herein, the first message is used for triggering a reception of a data unit of the first PDCP entity via the at least one RLC entity of the reserved cell group in the first time window.

In one embodiment, the second transmitter 1401 transmits a data unit of the first PDCP entity via the at least one RLC entity of the reserved cell group after an end of the first time window set.

In one embodiment, the second receiver 1402 receives a data unit of the first PDCP entity via the at least one RLC entity of the target cell group after an end of the first time window set.

In one embodiment, a transmitter of the first message maintains a MAC entity of the first cell group and a MAC entity of the second cell group within the first time window set.

In one embodiment, the second node is a satellite.

In one embodiment, the second node is a UE.

In one embodiment, the second node is an IoT node.

In one embodiment, the second node is a wearable node.

In one embodiment, the second node is a base station.

In one embodiment, the second node is a relay.

In one embodiment, the second node is an access point.

In one embodiment, the second node is a multicast-supporting node.

In one embodiment, the second node is a satellite.

In one embodiment, the second transmitter 1401 comprises at least one of the antenna 420, the transmitter 418, the transmitting processor 416, the multi-antenna transmitting processor 471, the controller/processor 475 or the memory 476 in Embodiment 4.

In one embodiment, the second receiver 1402 comprises at least one of the antenna 420, the receiver 418, the receiving processor 470, the multi-antenna receiving processor 472, the controller/processor 475 or the memory 476 in Embodiment 4.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The UE and terminal in the present application include but are not limited to unmanned aerial vehicles, communication modules on unmanned aerial vehicles, telecontrolled aircrafts, aircrafts, diminutive airplanes, mobile phones, tablet computers, notebooks, vehicle-mounted communication equipment, wireless sensor, network cards, terminals for Internet of Things (IOT), RFID terminals, NB-IOT terminals, Machine Type Communication (MTC) terminals, enhanced MTC (eMTC) terminals, data cards, low-cost mobile phones, low-cost tablet computers, satellite communication equipment, ship communication equipment, and NTN UE, etc. The base station or system device in the present application includes but is not limited to macro-cellular base stations, micro-cellular base stations, home base stations, relay base station, gNB (NR node B), Transmitter Receiver Point (TRP), NTN base station, satellite equipment and fight platform, and other radio communication equipment, eNB (LTE node B), test equipment like transceiving device simulating partial functions of base station or signaling tester.

The above are merely the preferred embodiments of the present application and are not intended to limit the scope of protection of the present application. Any modification, equivalent substitute and improvement made within the spirit and principle of the present application are intended to be included within the scope of protection of the present application.

What is claimed is:

1. A first node for wireless communications, comprising:
a first receiver, receiving a first signaling and a second signaling; the first signaling configuring at least one Radio Link Control (RLC) entity of a first cell group, while the second signaling configuring at least one RLC entity of a second cell group; and
a first transmitter, transmitting a first message, the first message requesting a stop of transmission for a target cell group within a first time window set; the first time window set at least comprising one time window;
wherein the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

2. The first node according to claim 1, characterized in comprising:
the first receiver, receiving a second message on a third cell group within the first time window set;
wherein frequency-domain resources occupied by the third cell group are used to determine the target cell group from the first cell group and the second cell group.

3. The first node according to claim 1, characterized in comprising:
the first transmitter, transmitting a third message on a third cell group within the first time window set;
wherein frequency-domain resources occupied by the third cell group are used to determine the target cell group from the first cell group and the second cell group.

4. The first node according to claim 2, characterized in that
the first node is not capable of being in communication with the target cell group and the third cell group simultaneously.

5. The first node according to claim 3, characterized in that
the first node is not capable of being in communication with the target cell group and the third cell group simultaneously.

6. The first node according to claim 1, characterized in comprising:
the first receiver, receiving a fourth message;
wherein the fourth message is used for acknowledging a request of the first message.

7. The first node according to claim 6, characterized in that
a reception of the fourth message is used for deactivating the target cell group; the target cell group is in a deactivated state within the first time window set; after an end of the first time window set, the first node activates the target cell group.

8. The first node according to claim 7, characterized in that
the first node maintains the first RLC entity and the second RLC entity within the first time window set.

9. The first node according to claim 1, characterized in that
the first time window set only comprises one time window, or, the first time window set comprises multiple time windows that occur periodically in time domain.

10. The first node according to claim 4, characterized in that
the first time window set only comprises one time window.

11. The first node according to claim 5, characterized in that
the first time window set only comprises one time window.

12. The first node according to claim 9, characterized in comprising:
the first receiver, receiving a fourth message;
wherein the fourth message is used for acknowledging a request of the first message; the first time window set only comprises a first time window; the fourth message indicates a start of the first time window.

13. The first node according to claim 1, characterized in that
the first message requests a stop of reception for at least one cell in the target cell group within the first time window set.

14. The first node according to claim 1, characterized in comprising:
the first transmitter, as a response to determining a link failure of a reserved cell group, transmitting a fifth message on the target cell group within the first time window set;
wherein the fifth message indicates the link failure of the reserved cell group, where the reserved cell group is a cell group other than the target cell group between the first cell group and the second cell group.

15. The first node according to claim 1, characterized in comprising:
the first receiver, receiving a data unit of a first Packet Data Convergence Protocol (PDCP) entity via the at least one RLC entity of the target cell group before the action of transmitting the first message; and receiving a data unit of the first PDCP entity via the at least one RLC entity of a reserved cell group in the first time window set, where the reserved cell group is a cell group other than the target cell group between the first cell group and the second cell group;
wherein the first message is used for triggering a reception of a data unit of the first PDCP entity via the at least one RLC entity of the reserved cell group in the first time window set.

16. The first node according to claim 15, characterized in comprising:
the first transmitter, transmitting a data unit of the first PDCP entity via the at least one RLC entity of the target cell group after an end of the first time window set.

17. The first node according to claim 4, characterized in that
the first node performs a second operation for a second timer of at least one cell in the target cell group within the first time window; the second operation includes stopping.

18. The first node according to claim 5, characterized in that
the first node performs a second operation for a second timer of at least one cell in the target cell group within the first time window; the second operation includes stopping.

19. A second node for wireless communications, comprising:
a second transmitter, transmitting a first signaling and a second signaling; the first signaling configuring at least one Radio Link Control (RLC) entity of a first cell group, while the second signaling configuring at least one RLC entity of a second cell group; and
a second receiver, receiving a first message, the first message requesting a stop of transmission for a target cell group within a first time window set; the first time window set at least comprising one time window;
wherein the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.

20. A method in a first node for wireless communications, comprising:
receiving a first signaling and a second signaling; the first signaling configuring at least one Radio Link Control (RLC) entity of a first cell group, while the second signaling configuring at least one RLC entity of a second cell group; and
transmitting a first message, the first message requesting a stop of transmission for a target cell group within a first time window set; the first time window set at least comprising one time window;
wherein the target cell group is one of the first cell group or the second cell group, where each of the first cell group and the second cell group respectively comprises at least one cell; at least one of the at least one RLC entity of the first cell group or the at least one RLC entity of the second cell group is maintained in the first time window set.
